(19) United States
(12) Patent Application Publication
(10) Pub. No.: US 2024/0430868 A1
(43) Pub. Date: Dec. 26, 2024

(54) SWITCHING BETWEEN FLEXIBLE BANDWIDTH PARTS

(71) Applicant: QUALCOMM Incorporated, San Diego, CA (US)

(72) Inventors: Ahmed Attia ABOTABL, San Diego, CA (US); Ahmed ELSHAFIE, San Diego, CA (US); Alexandros MANOLAKOS, Athens, Attikí (GR); Muhammad Sayed Khairy ABDELGHAFFAR, San Jose, CA (US); Hung Dinh LY, San Diego, CA (US)

(21) Appl. No.: 18/708,199

(22) PCT Filed: Nov. 21, 2022
(86) PCT No.: PCT/US2022/080229

§ 371 Date: May 7, 2024

(30) Foreign Application Priority Data
Jan. 5, 2022 (GR) 20220100002

(51) Int. Cl. H04W 72/0446; H04L 5/00

(52) U.S. Cl. CPC H04W 72/0446; H04L 5/0098

(57) ABSTRACT

Aspects are provided for switching flexible bandwidth parts (BWPs) according to one or more communication metrics or power metrics of one or more of a user equipment (UE) or a base station. In certain aspects, the UE may be configured to receive, from a base station, a command to switch from a first bandwidth part (BWP), wherein the first BWP is associated with a first bandwidth and a first slot format dedicated for the first BWP. In certain aspects, the UE may be configured to switch from the first BWP to a second BWP, wherein: the first bandwidth is switched to a second bandwidth, the first slot format is switched to a second slot format, or the first bandwidth is switched to the second bandwidth and the first slot format is switched to the second slot format.

### CROSS REFERENCE TO RELATED APPLICATION(S)

This application claims the benefit of Greek patent application No. 20220100002, entitled “SWITCHING BETWEEN FLEXIBLE BANDWIDTH PARTS” and filed on Jan. 5, 2022, which is incorporated herein by reference in its entirety.

### BACKGROUND

### Technical Field

The present disclosure generally relates to communication systems, and more particularly, to a wireless communication system between a user equipment (UE) and a base station.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to an apparatus for wireless communication by a user equipment (UE). The UE may include a processor; memory coupled with the processor; and instructions stored in the memory and operable, when executed by the processor. In some examples, the instructions may be configured to cause the apparatus to receive, from a base station, a command to switch from a first bandwidth part (BWP), wherein the first BWP is associated with a first bandwidth and a first slot format dedicated for the first BWP. In some examples, the instructions may be configured to cause the apparatus to switch from the first BWP to a second BWP, wherein: the first bandwidth is switched to a second bandwidth, the first slot format is switched to a second slot format, or the first bandwidth is switched to the second bandwidth and the first slot format is switched to the second slot format.

Certain aspects are directed to an apparatus for wireless communication by a base station. The base station may include a processor; a memory coupled with the processor; and instructions stored in the memory and operable, when executed by the processor. In some examples, the instructions may be configured to cause the apparatus to establish a communication link with a user equipment (UE), the communication link defined by a first bandwidth part (BWP), wherein the first BWP is associated with a first bandwidth and a first slot format dedicated for the first BWP. In some examples, the instructions may be configured to cause the apparatus to transmit, to the UE, a command to switch from the first BWP to a second BWP, wherein the switch is: from the first bandwidth to a second bandwidth associated with the second BWP, from the first slot format to a second slot format dedicated for the second BWP, or from the first bandwidth to the second bandwidth and from the first slot format to the second slot format.

Certain aspects are directed to a method of wireless communication at a user equipment (UE). In some examples, the method is directed to receiving, from a base station, a command to switch from a first bandwidth part (BWP), wherein the first BWP is associated with a first bandwidth and a first slot format dedicated for the first BWP. In certain aspects, the method is directed to switching from the first BWP to a second BWP, wherein: the first bandwidth is switched to a second bandwidth, the first slot format is switched to a second slot format, or the first bandwidth is switched to the second bandwidth and the first slot format is switched to the second slot format.

Certain aspects are directed to a method for wireless communication by a base station. In some examples, the method may include establishing a communication link with a user equipment (UE), the communication link defined by a first bandwidth part (BWP), wherein the first BWP is associated with a first bandwidth and a first slot format dedicated for the first BWP. In some examples, the method may include transmitting, to the UE, a command to switch from the first BWP to a second BWP, wherein the switch is: from the first bandwidth to a second bandwidth associated with the second BWP, from the first slot format to a second slot format dedicated for the second BWP, or from the first bandwidth to the second bandwidth and from the first slot format to the second slot format.

Certain aspects are directed to an apparatus for wireless communication. In some examples, the apparatus includes means for receiving, from a base station, a command to switch from a first bandwidth part (BWP), wherein the first BWP is associated with a first bandwidth and a first slot format dedicated for the first BWP. In certain aspects, the apparatus includes means for switching from the first BWP to a second BWP, wherein: the first bandwidth is switched to a second bandwidth, the first slot format is switched to a second slot format, or the first bandwidth is switched to the second bandwidth and the first slot format is switched to the second slot format.

Certain aspects are directed to an apparatus for wireless communication. In some examples, the apparatus includes means for establishing a communication link with a user equipment (UE), the communication link defined by a first bandwidth part (BWP), wherein the first BWP is associated with a first bandwidth and a first slot format dedicated for the first BWP. In some examples, the apparatus includes means for transmitting, to the UE, a command to switch from the first BWP to a second BWP, wherein the switch is: from the first bandwidth to a second bandwidth associated with the second BWP, from the first slot format to a second slot format dedicated for the second BWP, or from the first bandwidth to the second bandwidth and from the first slot format to the second slot format.

Certain aspects are directed to a non-transitory computer-readable medium having instructions stored thereon that, when executed by a user equipment (UE), cause the UE to perform operations. In some examples, the operations include receiving, from a base station, a command to switch from a first bandwidth part (BWP), wherein the first BWP is associated with a first bandwidth and a first slot format dedicated for the first BWP. In some examples, the operations include switching from the first BWP to a second BWP, wherein: the first bandwidth is switched to a second bandwidth, the first slot format is switched to a second slot format, or the first bandwidth is switched to the second bandwidth and the first slot format is switched to the second slot format.

Certain aspects are directed to a non-transitory computer-readable medium having instructions stored thereon that, when executed by a base station, cause the base station to perform operations. In some examples, the operations include establishing a communication link with a user equipment (UE), the communication link defined by a first bandwidth part (BWP), wherein the first BWP is associated with a first bandwidth and a first slot format dedicated for the first BWP. In some examples, the operations include transmitting, to the UE, a command to switch from the first BWP to a second BWP, wherein the switch is: from the first bandwidth to a second bandwidth associated with the second BWP, from the first slot format to a second slot format dedicated for the second BWP, or from the first bandwidth to the second bandwidth and from the first slot format to the second slot format.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIGS. 4A-4C are diagrams illustrating different examples of full-duplexing in which a UE may receive and transmit data to a base station at the same time.

FIG. 5 is a diagram illustrating an example of a band including flexible bandwidth parts (BWPs).

FIG. 6 is a diagram illustrating an example of a band in which a UE may switch between flexible BWPs.

FIG. 7 is a diagram illustrating another example of a band in which a UE may switch between flexible BWPs.

FIG. 8 is a diagram illustrating another example of a band in which a UE may switch between flexible BWPs.

FIG. 9 is a call flow diagram illustrating a first example process for switching between flexible BWPs.

FIG. 10 is a call flow diagram illustrating a second example process for switching between flexible BWPs.

FIG. 11 is a call flow diagram illustrating a second example process for switching between flexible BWPs.

FIG. 12 is a flowchart of a method of wireless communication at a UE.

FIG. 13 is a flowchart of a method of wireless communication at a base station.

FIG. 14 is a diagram illustrating an example of a hardware implementation for an example apparatus.

FIG. 15 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Generally, a BWP is a contiguous set of physical resource blocks (PRBs) for a given numerology on a given carrier. BWPs facilitate power-efficient communication between a base station and a UE on the given carrier or band. For instance, a base station may assign resources specifically within an active BWP for a UE (as opposed to broadly within PRBs of the entire band), and the UE may search for data or signaling from the base station in the active BWP rather than within PRBs of the entire band.

A base station and UE may switch BWPs. Switching BWPs involves activating a configured (de-activated) BWP and de-activating an active BWP. When switching BWPs, the base station and UE may switch between downlink (DL) BWPs and between uplink (UL) BWPs simultaneously in time division duplex (TDD) deployments and independently in frequency division duplex (FDD) deployments. Moreover, in TDD deployments, the base station may provide a common or dedicated slot format configuration to the UE indicating which symbols of a slot are downlink or uplink, and the activated DL BWP or UL BWP may be applied in DL or UL symbols accordingly.

TDD deployments and FDD deployments may be half-duplex or full-duplex. In half-duplex communication, a base station or UE may transmit and receive data at different times, but not at the same time. In contrast, in full-duplex communication, a base station or UE may transmit and receive data at the same time. One example of full-duplex communication is in-band full duplex (IBFD), in which a base station or UE may transmit and receive data in at least part of (or all of) the same frequency resource(s). Another example of full-duplex communication is sub-band FDD (also referred to as flexible duplex), in which a base station or UE may transmit and receive data in different frequency resources.

Conventional BWPs inflexibly follow the timing of a slot format configuration for the cell or a UE. For instance, in TDD deployments, if a base station configures a common or dedicated slot format to include specified DL and UL symbols at different times, the base station and UE may conventionally apply only a DL BWP during the DL symbols and only an UL BWP during the UL symbols. In contrast, the base station and UE may not apply a single BWP for both DL and UL symbols. While this inflexibility in conventional BWPs may suffice with respect to half duplex communication, this inflexibility may interfere with full duplex communication. For instance, if a DL BWP and UL BWP are separately activated according to a timing of a TDD slot format configuration, the DL BWP and the UL BWP may not be activated at the same time for full duplexing. As a result, the base station and UE may not be able to apply such BWPs for full duplexing. Therefore, it would be helpful to provide more flexible BWPs with respect to timing, rather than the conventional BWPs which inflexibly follow a cell or UE slot format, in order to facilitate full-duplex operation.

As noted, in TDD deployments, the base station may provide a common slot format and/or one or more dedicated slot format configurations to the UE indicating which symbols of a slot are downlink or uplink, and the slot format (e.g., DL or UL symbol pattern) may be applied to a BWP accordingly. The base station may also indicate which of the one or more dedicated slot formats are active for the BWP. For example, if the base station configures the UE with four dedicated slot formats for the BWP, then the base station may also provide the UE with an indication of which of the four dedicated slot formats or the common slot format will be active (e.g., indicating which of the slot formats will be used for communication over the BWP). Each of the common slot format and the one or more dedicated slot formats may be defined by different DL and UL symbol patterns. Thus, a first slot format may include more DL symbols than UL symbols (e.g., more DL slots than UL slots), and a second slot format may include more UL symbols than DL symbols (e.g., more UL slots than DL slots). It should be noted that each of the different symbol patterns may affect the power consumption at the UE and base station.

For example, if the UE and base station communicate over BWP using a slot format that includes more DL symbols than UL symbols, then the base station may use relatively more power than the UE because the base station may perform more signal transmission. Whereas if the slot format includes more UL symbols than DL symbols, then the UE may use relatively more power than the base station because the UE may perform more signal transmission. In the latter example, such a slot format may have an adverse effect on the UE if the UE has a low battery. Power headroom and power saving modes of the UE, as well as power saving modes of the base station may also conflict with the active slot format. Other considerations may include an amount of UL traffic by the UE and/or an amount of DL traffic by the base station. Accordingly, it would be helpful to provide the UE and the base station with a capability to switch between BWP and/or slot formats that are more favorable to one or more power metrics of one or more of the UE of the base station.

Accordingly, aspects of the present disclosure provide techniques for switching between BWPs and/or slot formats according to the power metrics or communication metrics of one or more of the UE of the base station. Such BWPs are referred to throughout this disclosure as “flexible BWPs.” Moreover, aspects of the present disclosure provide various approaches for switching between flexible BWPs in frequency and/or time.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

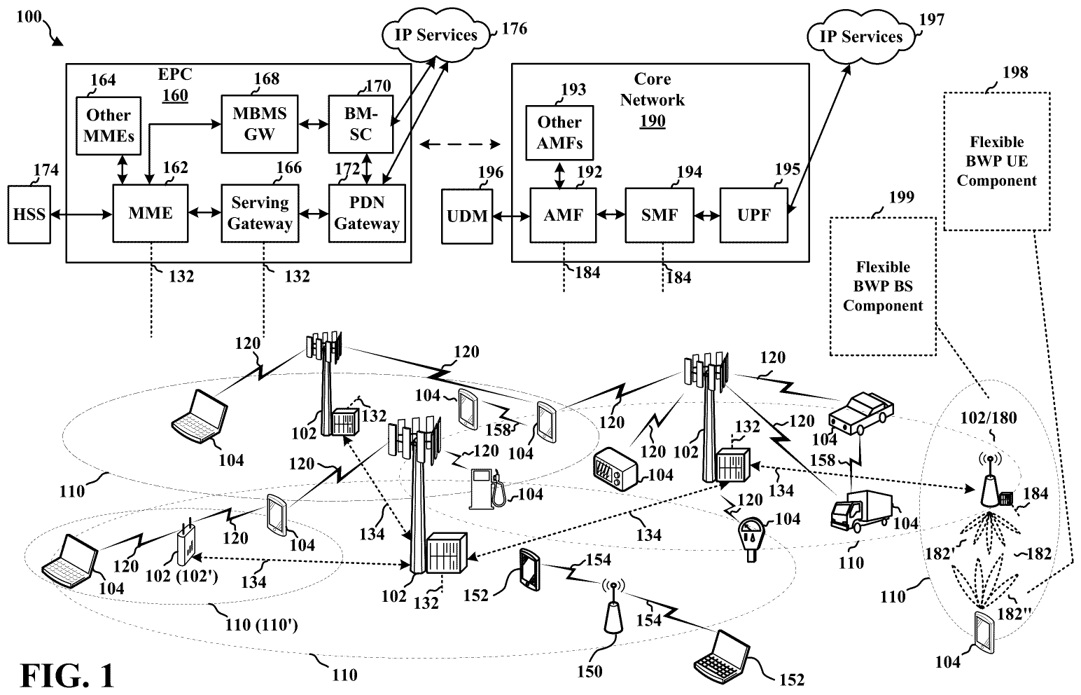

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Referring again to FIG. 1, in certain aspects, the UE 104 may include a flexible BWP UE component 198 that is configured to receive, from a base station, a command to switch from a first bandwidth part (BWP), wherein the first BWP is associated with a first bandwidth and a first slot format dedicated for the first BWP. The flexible BWP UE component 198 may be further configured to switch from the first BWP to a second BWP, wherein: the first bandwidth is switched to a second bandwidth, the first slot format is switched to a second slot format, or the first bandwidth is switched to the second bandwidth and the first slot format is switched to the second slot format.

Referring again to FIG. 1, in certain aspects, the base station 102, 180 may include a flexible BWP BS component 199 that is configured to establish a communication link with a user equipment (UE), the communication link defined by a first bandwidth part (BWP), wherein the first BWP is associated with a first bandwidth and a first slot format dedicated for the first BWP. The flexible BWP BS component 199 may also be configured to transmit, to the UE, a command to switch from the first BWP to a second BWP, wherein the switch is: from the first bandwidth to a second bandwidth associated with the second BWP, from the first slot format to a second slot format dedicated for the second BWP, or from the first bandwidth to the second bandwidth and from the first slot format to the second slot format.

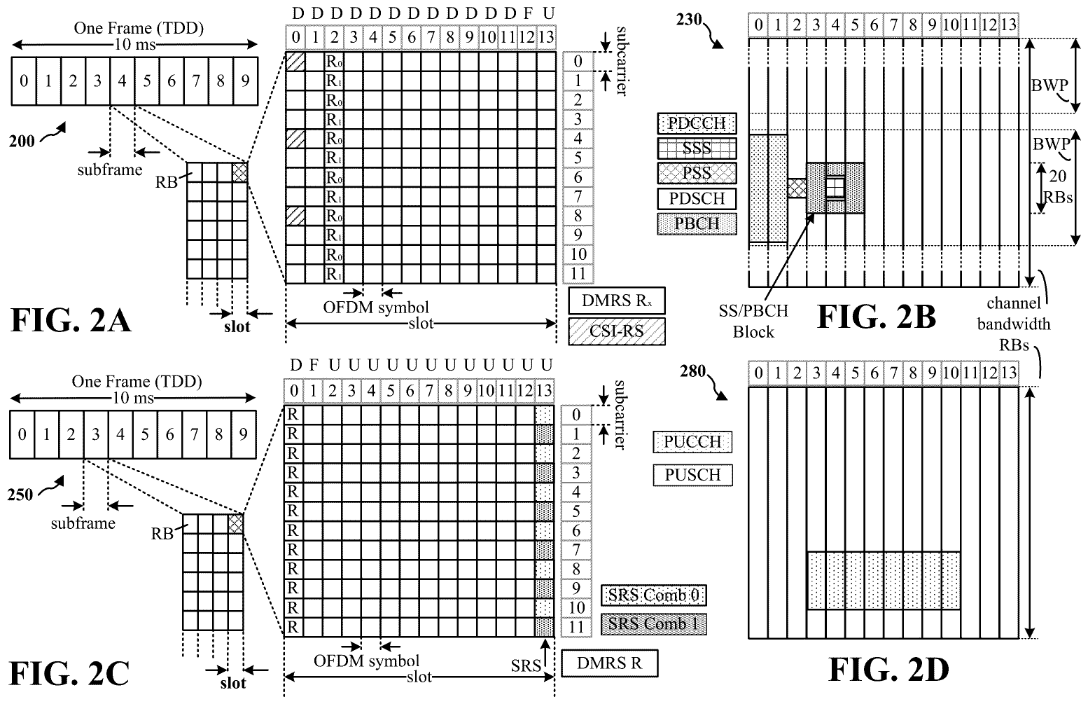

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 24 slots/subframe. The subcarrier spacing and symbol length/duration are a function of the numerology. The subcarrier spacing may be equal to 24*15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

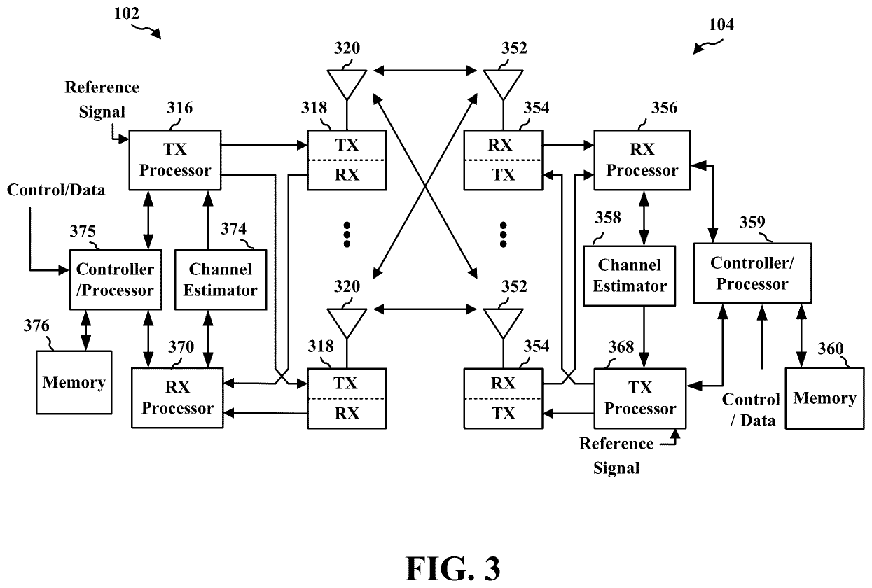

FIG. 3 is a block diagram of a base station 102 (e.g., base station 102/180 of FIG. 1) in communication with a UE 104 (e.g., UE 104 of FIG. 1) in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102. These soft decisions may be based on channel estimates computed by the channel estimator 358. The soft decisions are then decoded and deinterleaved to recover the data and control signals that were originally transmitted by the base station 102 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with flexible BWP UE component 198 of FIG. 1.

At least one of the TX processor 316, the RX processor 370, and the controller/processor 375 may be configured to perform aspects in connection with flexible BWP BS component 199 of FIG. 1.

Generally, time division duplex (TDD) deployments may be half-duplex or full-duplex. In half-duplex communication, a base station or UE may transmit and receive data at different times, but not at the same time. For example, the base station may configure the UE with a first BWP and a second BWP respectively occupying a plurality of DL symbols and a plurality of UL symbols in a band at different times. The base station may configure a UE with the first BWP and the second BWP in an RRC configuration. The base station may configure the DL symbols and UL symbols to occur in TDD according to a slot format configuration for the cell or UE.

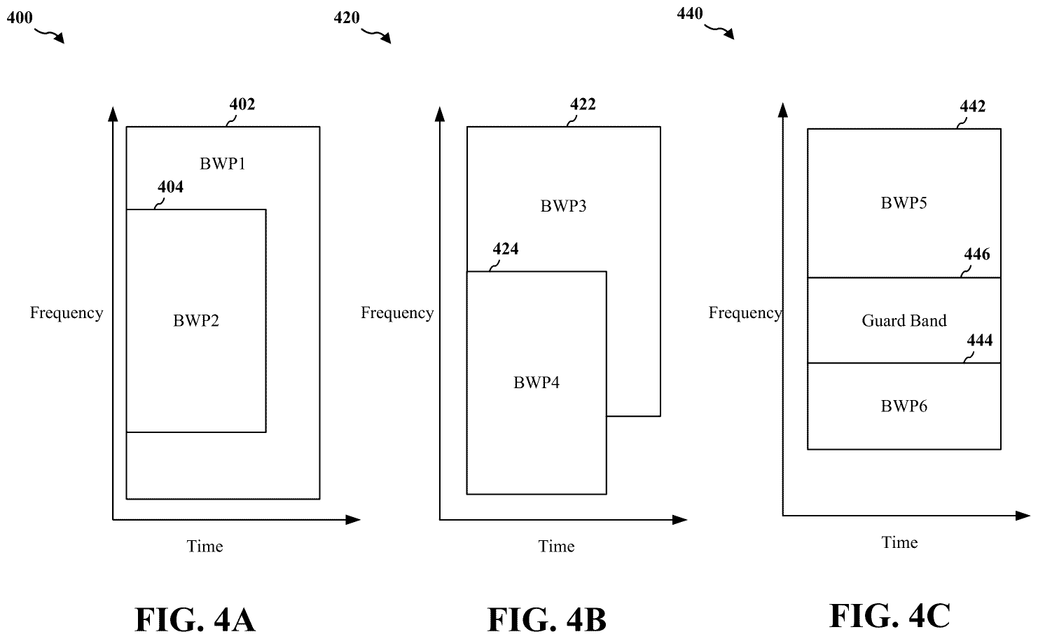

In contrast, in full-duplex communication, a base station or UE may transmit and receive data at the same time. One example of full-duplex communication is in-band full duplex (IBFD), in which a base station or UE may transmit and receive data in at least part of (or all of) the same frequency resource(s). For instance, FIG. 4A illustrates an example 400 of IBFD in which a first BWP 402 fully overlaps in frequency with a second BWP 404, and FIG. 4B illustrates an example 420 of IBFD in which a third BWP 422 partially overlaps in frequency with a fourth BWP 424. Thus, a pair of BWPs may share identical time-frequency resources with either full or partial frequency overlap in IBFD communication.

Another example of full-duplex communication is sub-band FDD (also referred to as flexible duplex), in which a base station or UE may transmit and receive data in different frequency resources. For instance, FIG. 4C illustrates an example 440 of sub-band FDD full duplexing in which a fifth BWP 442 and a sixth BWP 444 simultaneously occupy different frequency resources separated by a guard band 446 (e.g., 10-20 RBs or some other relatively small number of RBs). Thus, a pair of BWPs may overlap in time but not in frequency in sub-band FDD, and the frequency resources for uplink communication may be separated from the frequency resources for downlink communication by a guard band.

Generally, a bandwidth part (BWP) is a contiguous set of physical resource blocks (PRBs) for a given numerology on a given carrier. BWPs facilitate power-efficient communication between a base station and a UE on the given carrier or band. For instance, a base station may assign resources specifically within an active BWP for a UE (as opposed to broadly within PRBs of the entire band), and the UE may search for data or signaling from the base station in the active BWP rather than within PRBs of the entire band.

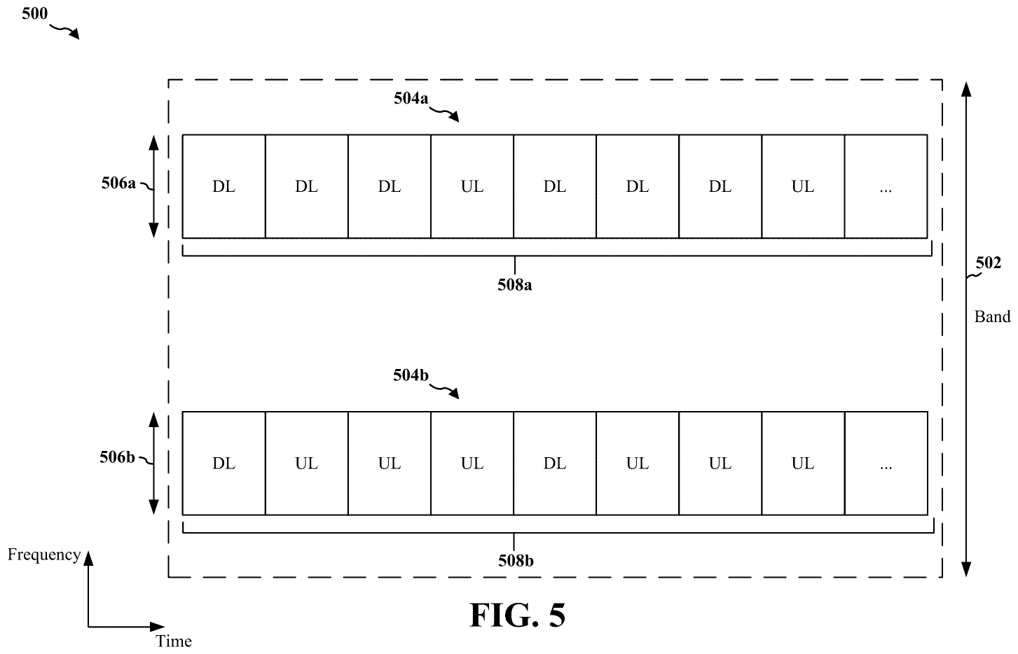

Certain aspects of the present disclosure provide a BWP which may flexibly include a dedicated slot format for that BWP which may include both DL and UL symbols. Such BWPs are referred to throughout this disclosure as “flexible BWPs.” For instance, FIG. 5 illustrates an example 500 of a band 502 including a first flexible BWP 504a associated with a first bandwidth 506a, and a second flexible BWP 504b associated with a second bandwidth 506b (e.g., a location and number of contiguous PRBs). The first flexible BWP 504a may also be associated with a first TDD slot format 508a (e.g., a pattern of DL, UL, and in some cases flexible symbols), and the second flexible BWP 504b may also be associated with a second TDD slot format 508b. In this example, the first flexible BWP 504a may be configured with one slot format including a repeating pattern of symbols: DL/DL/DL/UL, and the second bandwidth 506b may be configured with another slot format including a repeating pattern of symbols: DL/UL/UL/UL. It should be noted that the slot formats illustrated are provided as an example, and may be the same or different from those illustrated in other examples or in implementation. Moreover, although the first flexible BWP 504a and the second flexible BWP 504b in the illustrated example of FIG. 5 have the same number of contiguous PRBs (e.g., in the first bandwidth 506a and the second bandwidth 506b), the number of PRBs in each BWP may be different in other examples.

In certain aspects, a base station may provide a radio resource control (RRC) configuration to a UE, such as an RRC reconfiguration, which may configure the UE with flexible BWPs with various parameters for communication with the base station. These RRC parameters may include, for example, a BWP identifier or index for each BWP, a location and number of contiguous PRBs in frequency for each BWP, a subcarrier spacing for each BWP, and a cyclic prefix for each BWP. Moreover, the RRC configuration may indicate an initial downlink BWP for initial downlink transmissions (e.g., a control resource set (CORESET) #0), an initial uplink BWP for initial uplink transmissions (e.g., following reconfiguration or activation of a cell), a BWP inactivity timer (e.g., a timer which may increment by 0.5 or 1 ms depending on frequency range each period that a DCI is not received), and a default downlink BWP (e.g., a DL BWP to which the base station and UE may switch in response to expiration of the BWP inactivity timer). Generally, a base station may configure up to four DL BWPs and up to four UL BWPs for a UE, of which only 1 BWP may be active in a UL or DL direction at a given time. The RRC configuration may also include a bit or other indicator associated with a BWP index indicating whether the corresponding BWP is flexible (or conventional), and if the BWP is flexible, the base station may configure a dedicated slot format for the BWP in that RRC configuration. In some cases, the base station may not configure a dedicated slot format for a flexible BWP, but rather allow the BWP to take a dedicated slot format of another flexible BWP during BWP switching, such as described in more detail below. If the BWP is flexible but does not have a dedicated slot format, the base station may configure the UE with a common slot format to use with any BWP that does not have a dedicated slot format.

Flexible BWPs may enable or facilitate full-duplex operation. For instance, a base station and UE may activate multiple flexible BWPs in a band with different slot formats (e.g., the first flexible BWP 504a and the second BWP 504b in FIG. 5) such that one active BWP includes at least one DL symbol at the same time that another active BWP includes at least one UL symbol, thereby allowing the base station and UE to communicate in full-duplex within those symbol(s). Moreover, flexible BWPs may add more flexibility to network assignments and allow for simultaneous handling of half-duplex UEs, full-duplex UEs, and full-duplex aware UEs (e.g., half-duplex UEs which are capable of full-duplex communication with the base station). Additionally, flexible BWPs may be widely applicable not only to full-duplex communication, but also to half-duplex communication (e.g., dynamic TDD deployments), as well as in both TDD and FDD deployments.

In some examples, a flexible BWP (e.g., the first flexible BWP 504a of FIG. 5) may include a bandwidth (e.g., first bandwidth 506a) and one or more dedicated slot formats (e.g., first slot format 508a). Different flexible BWPs (associated with different BWP indices) may be configured with different bandwidths, and in some cases, different slot formats. The UE may thus switch either: the bandwidth of the flexible BWP to another bandwidth, the slot format of the flexible BWP to another slot format, or both the bandwidth and the slot format of the flexible BWP to another bandwidth or slot format respectively. To allow the UE to determine which parts of a flexible BWP to switch, the base station may indicate the UE in a DCI or an RRC reconfiguration whether to switch the bandwidth and/or slot format.

For example, to indicate a flexible BWP for switching in DCI, the base station may include a bandwidth part indicator field indicating a BWP index for a new active BWP (and thus a new bandwidth) to which the UE will switch in response to the DCI. Alternatively, the bandwidth part indicator field may indicate the same BWP index (and thus the same bandwidth or BWP) which the UE will maintain in response to the DCI. In addition to the bandwidth part indicator field, the DCI may also include a slot format indicator field including one or more bits indicating one of multiple slot formats to which the UE will switch (or indicating whether the UE will maintain the previous slot format) in response to the DCI. For example, if the slot format indicator field of DCI is configured with a first value, the UE may determine to maintain the slot format of the previous active BWP (e.g., the active BWP at the time the DCI was received), if the slot format indicator field is configured with a second value, the UE may determine to switch the slot format to a dedicated slot format of the current active BWP (e.g., indicated in the bandwidth part indicator field), and if the slot format indicator field is configured with a third value, the UE may determine to switch the slot format to another dedicated slot format (if existing) of the current active BWP. Additionally, in some examples, the bandwidth part indicator field may indicate multiple BWP indices from which the UE may determine to activate multiple new active BWPs (e.g., for full duplex communication), or the DCI may include multiple such bandwidth part indicator fields each indicating a BWP index. In such examples, the slot format indicator field may include multiple configured values (one for each active BWP indicating whether to maintain or switch a slot format), or the DCI may include multiple slot format indicator fields each indicating one of such configured values. In response to receiving the DCI, the UE may switch the bandwidth and/or slot format as indicated in the bandwidth part indicator and slot format indicator fields. Similarly, to indicate a flexible BWP for switching in an RRC configuration, the base station may configure a first active flexible BWP (e.g., an RRC parameter in the configuration) with one of multiple bandwidths and/or slot formats to which the UE will switch following reconfiguration or activation of a cell. The bandwidth for the first active flexible BWP may be indicated, for example, by a configured BWP index, which may be associated with a configured bandwidth in the RRC configuration as previously described. The slot format for the first active flexible BWP may similarly be indicated by the configured BWP index (which may be associated with its own dedicated slot format in the RRC configuration as previously described), or by a separate slot format parameter indicating one of multiple dedicated slot formats for the configured BWP index. In response to receiving the RRC reconfiguration or in response to activating a cell, the UE may switch the bandwidth and/or slot format as indicated by the first active flexible BWP.

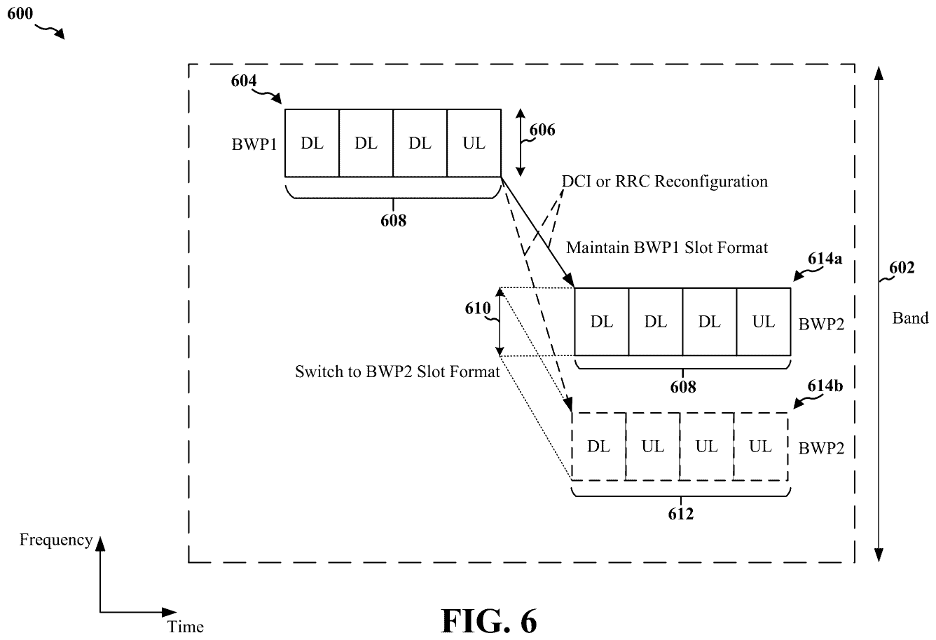

FIG. 6 illustrates an example 600 of a band 602 including flexible BWPs including BWP1 604 and BWP2 614, where BWP1 604 is associated with a first bandwidth 606 and a first slot format 608 (e.g., DL/DL/DL/UL repeating such in BWP1 604 of FIG. 6), and where BWP2 614 is associated with a second bandwidth 610 and a second slot format 612 (e.g., DL/UL/UL/UL repeating such as in BWP2 614 of FIG. 6). That is, while FIG. 6 illustrates two instances of BWP2 (e.g., a first instance of BWP2 614a and a second instance of BWP2 614b), both instances share the same second bandwidth 610. The bandwidth and slot format of each BWP may be previously configured in an RRC configuration (e.g., a previous RRC reconfiguration). While BWP1 604 is active, the base station may provide a DCI or RRC reconfiguration to the UE indicating the UE to switch from the first bandwidth 606 of BWP1 604 to that of BWP2 614, and/or the first slot format 608 of BWP1 604 to the second slot format 612 of BWP2 614 (or alternatively to maintain the slot format of BWP1).

For example, if the base station indicates in DCI or the RRC reconfiguration to maintain the first slot format 608 of BWP1 for BWP2 (e.g., illustrated by the first instance of BWP2 614a in solid lines), the UE may switch from the first bandwidth 606 to the second bandwidth 610 of the first instance of BWP2 614a but refrain from switching from the first slot format 608 to the second slot format 612 of BWP2 614 (thus maintaining the first slot format 608 for the switch to BWP2), in response to the DCI or following reconfiguration or activation of a cell. Alternatively, if the base station indicates in the DCI or the RRC reconfiguration to switch to the second slot format 612 of BWP2 614 rather than maintain the first slot format 608 of BWP1 604 (e.g., illustrated by the second instance of BWP2 in dashed lines), the UE may switch from the first bandwidth 606 to the second bandwidth 610 of BWP2 614, as well as switch from the first slot format 608 to the second slot format 612 of BWP2, in response to the DCI or following reconfiguration or activation of a cell.

As described in the above example, a base station may configure each flexible BWP with a dedicated slot format (e.g., in a RRC configuration), and the base station may indicate a UE to either switch from one BWP slot format to another or to maintain the previous BWP slot format (e.g., through an indication in DCI or in a RRC reconfiguration). For example, the second slot format 612 may be a dedicated slot format for BWP2 614, and the first slot format 608 may be a dedicated slot format for BWP1 604. However, in another example, one or more of these BWPs may not be configured with a dedicated slot format in the RRC configuration (e.g., in a TDD deployment). In such case, if the base station indicates the UE to switch to the slot format of a new active BWP rather than maintain the previous slot format as previously described, the UE may switch the slot format of the new active BWP to that of a band slot format (e.g., the common or dedicated slot format for the cell or UE, rather than a dedicated slot format for a BWP). For instance, in response to receiving a DCI or RRC reconfiguration indicating a new active BWP in a band and indicating to switch the slot format of the current BWP to that of the new active BWP, and in response to determining that the new active BWP is not configured with a dedicated slot format, the UE may switch to the band slot format including the new active BWP. Thus, the band slot format may effectively serve as a default slot format for a flexible BWP which the base station did not configure but still indicates for switching.

Alternatively, in another example, the base station may indicate the UE to switch the slot format of a current BWP to the band slot format even if the BWP is configured with a dedicated slot format in the RRC configuration. For example, if the base station provides a DCI including a slot format indicator field configured with a specific value, the UE may determine to switch the slot format of the new active BWP (e.g., indicated in the bandwidth part indicator field) to the band slot format. In either example, the UE may transmit and receive data in the new active BWP according to the current DL/UL symbols in the band slot format. For example, if the band slot format is DL/DL/DL/DL/DL/UL/UL/UL (repeating every eight symbols), and the UE switches to the band slot format at the sixth symbol (UL), the UE may communicate in the new active BWP starting in the UL direction at the sixth symbol and follow the band slot format symbol by symbol accordingly.

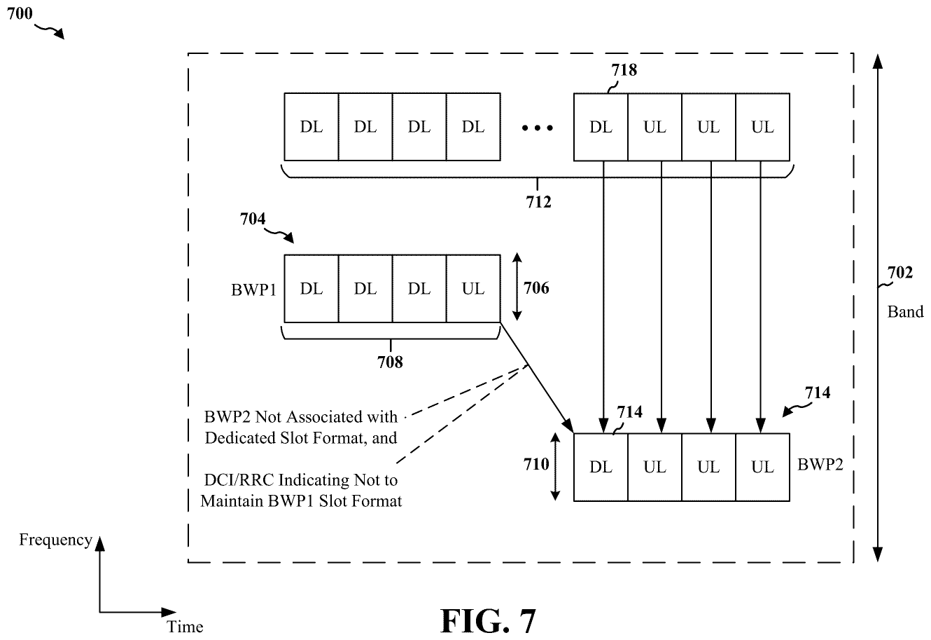

FIG. 7 illustrates an example 700 of a band 702 including flexible BWPs including BWP1 704 and BWP2 714, where BWP1 704 is associated with a first bandwidth 706 and a first slot format 708 (e.g., DL/DL/DL/UL repeating such in BWP1 604 of FIG. 6), and where BWP2 714 is associated with a second bandwidth 710 but is not associated with its own dedicated slot format. The bandwidth 706, 710 of each of the BWPs may be previously configured in an RRC configuration (e.g., a previous RRC reconfiguration), and only the first slot format 708 of BWP1 704 (and not BWP2 714) may be previously configured in the RRC configuration. While BWP1 704 is active, the base station may provide a DCI or RRC reconfiguration to the UE indicating the UE to switch from the first bandwidth 706 of BWP1 704 to that of BWP2 714, and switch from the first slot format 708 of BWP1 704 to that of a band slot format 712 (e.g., as configured in a common or dedicated TDD slot format configuration). For example, if the base station indicates in DCI or the RRC reconfiguration to switch the first slot format 708 of BWP1 704 rather than maintain the first slot format 708, and if BWP2 714 is not associated with its own dedicated slot format, the UE may switch from the first slot format 708 to the band slot format 712 for BWP2 714 (as well as from the first bandwidth 706 to the second bandwidth 710 of BWP2 714) in response to the DCI or following reconfiguration or activation of a cell. Alternatively, the base station may indicate in DCI or the RRC reconfiguration to switch the first slot format 708 to the band slot format 712 for BWP2 714 even if BWP2 714 is associated with its own dedicated slot format in the RRC configuration. Once the UE switches to the band slot format 712 for BWP2 714, the UE may communicate with the base station according to the current DL/UL symbol of the band slot format 712. For example, as illustrated in FIG. 7, the UE may communicate with the base station in BWP2 714 starting in the DL direction indicated at a symbol 714 (aligned with a corresponding symbol 718 of the band slot format 712), and follow the band slot format symbol by symbol in BWP2 714 accordingly.

In certain aspects, it may be helpful to switch from one slot format to another slot format to accommodate a power metric or a communication metric of a UE and/or a base station. As illustrated in the example of FIG. 7, the first slot format 708 relies more heavily on DL TDD symbols than UL TDD symbols. However, if the base station uses a power savings mode, then the power savings may be implemented in the form of switching from the first slot format 708 to the band slot format 710. In this example, while the base station may continue to receive and decode UL transmissions, it will use relatively less power by transmitting DL signals less frequently. Similarly, if the UE needs more opportunity for uplink traffic, then switching from the first slot format 708 to the band slot format 710 may provide the UE with those opportunities. Thus, the base station may issue a switch command to the UE, commanding the UE to switch from BWP1 704 to BWP2 714 because BWP2 714 uses more UL symbols, thereby saving power at the base station and/or providing the UE with more UL opportunities.

As described in the above example, the base station may indicate the UE to switch a bandwidth of a current BWP to that of a new active BWP and to switch the slot format of the current BWP to that of the band slot format. For instance, in response to receiving a DCI indicating a new active BWP in a band and indicating to switch the slot format of a current BWP to that of the new active BWP, and in response to determining that the new active BWP is not configured with a dedicated slot format, the UE may switch to the bandwidth of the new active BWP and follow the band slot format for the new active BWP. In another example, the base station may indicate the UE to maintain the same bandwidth of the current BWP for the active BWP. For instance, the UE may receive a DCI (a downlink grant or uplink grant) which includes a bandwidth part indicator field indicating the same BWP index as that of the current BWP. In such case, if the DCI also includes a slot format indicator field indicating to follow the band slot format for the new active BWP such as previously described, then the UE may maintain the bandwidth of the current BWP for the new active BWP, while changing the slot format of the current BWP to that of the band slot format.

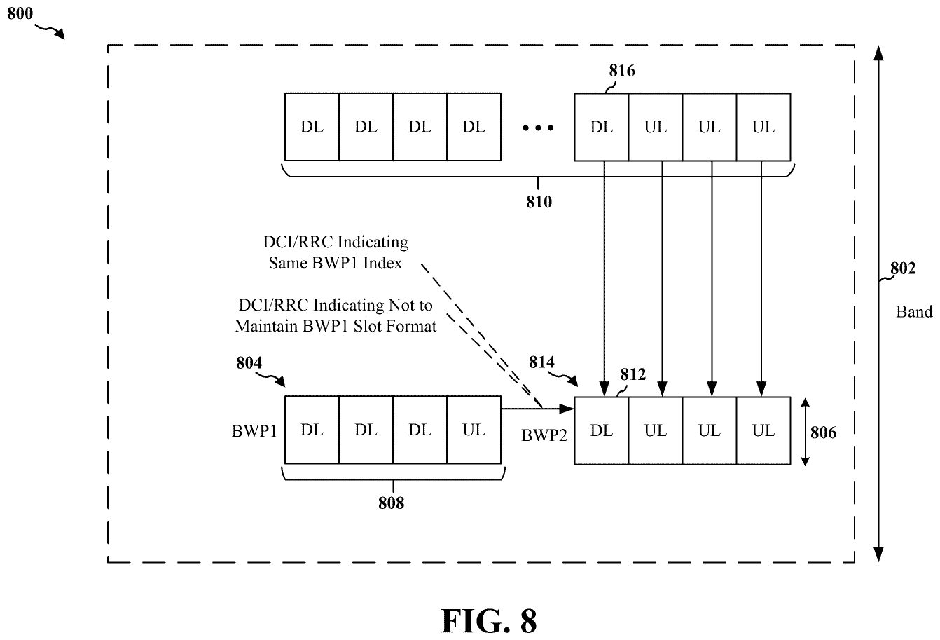

FIG. 8 illustrates an example 800 of a band 802 including flexible BWPs including BWP1 804 and BWP2 814, where BWP1 804 and BWP2 814 are each associated with a bandwidth 806 and a slot format 808 (e.g., DL/DL/DL/UL repeating such in BWP1 604 of FIG. 6). The bandwidth 806 and slot format 808 of the BWPs may be previously configured in an RRC configuration (e.g., a previous RRC reconfiguration). While BWP1 804 is active, the base station may provide a DCI to the UE indicating the UE to maintain the bandwidth of BWP1 804 for BWP2 814, but to switch the slot format of BWP1 804 to that of a band slot format 810 (e.g., as configured in a common or dedicated TDD slot format configuration). For example, if the base station indicates in DCI the same BWP index for BWP1 and indicates not to maintain the slot format 808 of BWP1 804, the UE may switch from slot format 808 to band slot format 810 for BWP2 814 in response to the DCI. Once the UE switches to the band slot format 810 for BWP2 814, the UE may communicate with the base station according to the current DL/UL symbol of the band slot format 810. For example, as illustrated in FIG. 8, the UE may communicate with the base station in BWP2 814 starting in the DL direction indicated at symbol 812 (aligned with a corresponding symbol 816 of the band slot format 810), and follow the band slot format symbol by symbol in BWP2 814 accordingly.

In certain aspects, it may be helpful to switch from one slot format to another slot format to accommodate a power metric or a communication metric of a UE and/or a base station. As illustrated in the example of FIG. 8, the slot format 808 relies more heavily on DL TDD symbols than UL. However, if the base station uses a power savings mode, then the power savings may be implemented in the form of switching from the slot format 808 to the band slot format 810. In this example, while the base station may continue to receive and decode UL transmissions, it will use relatively less power by transmitting DL signals less frequently. Similarly, if the UE needs more opportunity for uplink traffic, then switching from the slot format 808 to the band slot format 810 may provide the UE with those opportunities. Thus, the base station may issue a switch command to the UE, commanding the UE to switch from BWP1 804 to BWP2 814 because BWP2 814 uses more UL symbols, thereby saving power at the base station and/or providing the UE with more UL opportunities.

Example Techniques for Switching from a First BWP to a Second BWP

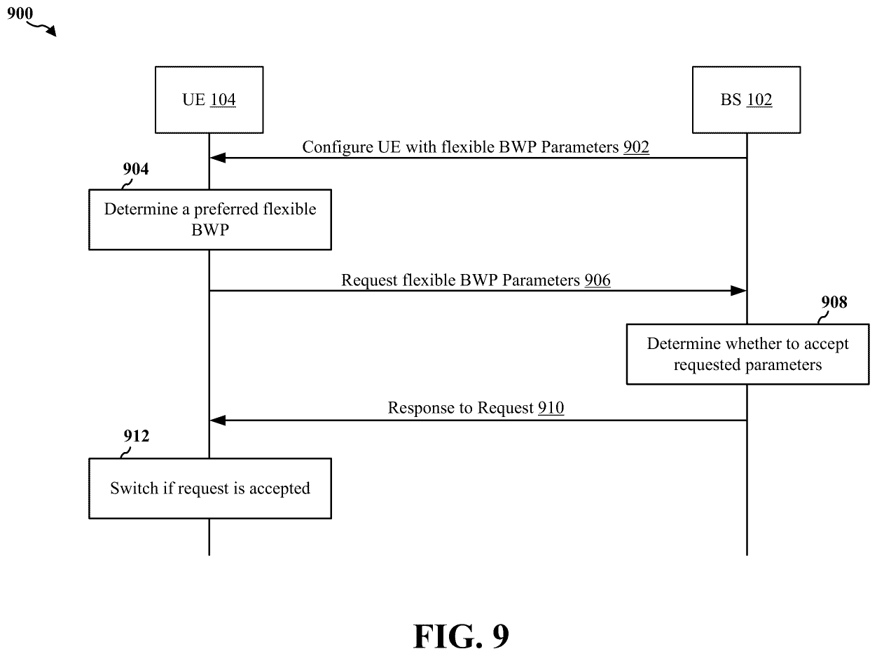

FIG. 9 is a call-flow diagram 900 illustrating an exemplary flexible BWP switching procedure as it might occur in accordance with one example of communication between a UE 104 and a base station (BS) 102 (e.g., the UE 104 and base station 102 of FIG. 1). In this illustration, time progresses in the downward direction, and communication signals between the illustrated entities are denoted with arrows between the lines below the respective entities. As illustrated, the base station 102 and UE 104 are in communication using flexible BWPs. Each of the UE 104 and the base station are configured for communication over flexible BWPs using DL and UL TDD symbols.

Initially, at a first communication 902, the base station 102 may transmit signaling to the UE 104 configured to configure the UE 104 with communication parameters of one or more BWPs. For example, a base station 102 may provide an RRC configuration to the UE 104, such as an RRC reconfiguration, which may configure the UE with flexible BWPs with various parameters for communication with the base station. The communication parameters may include, for example, a BWP identifier or index for each BWP, a location and number of contiguous PRBs in frequency for each BWP, a subcarrier spacing for each BWP, and a cyclic prefix for each BWP. Moreover, the RRC configuration may indicate an initial downlink BWP for initial downlink transmissions (e.g., a control resource set (CORESET) #0), an initial uplink BWP for initial uplink transmissions (e.g., following reconfiguration or activation of a cell), a BWP inactivity timer (e.g., a timer which may increment by 0.5 or 1 ms depending on frequency range each period that a DCI is not received), and a default downlink BWP (e.g., a DL BWP to which the base station and UE may switch in response to expiration of the BWP inactivity timer). The communication parameters may also include a bit or other indicator associated with a BWP index indicating whether the corresponding BWP is flexible (or conventional), and if the BWP is flexible, the base station may configure a dedicated slot format for the BWP in that RRC configuration. In some cases, the base station may not configure a dedicated slot format for a flexible BWP, but rather provide the UE 104 with a common slot format to use with the BWP.

The UE 104 may receive the first communication 902 and may then proceed to communicate with the base station 102 using the communication parameters of the one or more BWPs received from the base station 102. At a first process 904, the UE 104 may determine a flexible BWP communication parameter. For example, if the base station 102 configured the UE 104 with communication parameters corresponding to multiple flexible BWPs, then the UE 104 may select a particular one or more flexible BWP communication parameters that would best serve the UE 104 in future communications with the base station 102. In certain aspects, the UE 104 may base the selection on one or more of a communication metric or a power metric of the UE. For example, a UE power metric may relate to one or more of a UE battery level (e.g., battery life), UE power headroom (e.g., how much transmission power left for a UE to use in addition to the power being used by current transmission), and any other suitable power metrics.

In one example, if battery power of the UE 104 is low (e.g., the battery power drops below a pre-configured threshold value), then the UE 104 may select one or more communication parameters associated with the one or more BWPs received from the base station 102. The UE 104 may select the first flexible BWP to use its corresponding dedicated slot format, or the UE 104 may select a slot format regardless of whether the slot format is dedicated to a particular BWP. Thus, if the battery is low, the UE 104 may select a first BWP based on the dedicated slot format for that BWP having more DL symbols than UL symbols. Similarly, if the operational band is crowded with communications from other devices, then the UE 104 may determine to maintain the bandwidth of the current BWP, but select a slot format that has more DL symbols than UL symbols to use with the current BWP. As such, if the UE 104 and base station 102 switch to the selected first BWP and its corresponding dedicated slot format, or switch to the selected slot format, the UE 104 may use relatively less power because there may be fewer UL transmission opportunities.

In another example, if the UE 104 UL traffic is relatively high (e.g., the UE requires a slot pattern that provides more UL opportunities than the current slot pattern), then the UE may select a second BWP with a corresponding dedicated slot format having more UL opportunities than the current slot pattern, or the UE may instead select a slot format having more UL opportunities than the current slot pattern.

The UE 104 may also base the selection on a combination of a communication metric and a power metric of the UE. For example, if the battery power of the UE 104 has not dropped below the threshold value, and the UE's 104 UL traffic is relatively high, then the UE 104 may select a third BWP with a corresponding dedicated slot format having more UL opportunities than the current slot pattern, or the UE may instead select a slot format having more UL opportunities than the current slot pattern. In another example, if the battery power of the UE 104 has dropped below the threshold value (e.g., the battery power is low) and the UE's 104 UL traffic is relatively high, then the UE 104 may select a fourth BWP with a corresponding dedicated slot format having a moderate amount of UL opportunities than the current slot pattern, or the UE may instead select a slot format having a moderate amount of UL opportunities (e.g., a slot format that does not have the most or the least UL opportunities of the BWP communication parameters configured by the base station 102).

In a second communication 906, once the UE 104 has selected one or more communication parameters associated with the one or more BWPs received from the base station 102, the UE 104 may transmit a request to the base station 102 requesting a switch from the current BWP configuration to a new BWP configuration that includes the selected one or more communication parameters.

In response to the second communication 906, the base station 102 may perform a second process 908 to determine whether to accept the requested communication parameters. That is, the base station 102 may determine whether to switch from the current BWP configuration to a new BWP to use its dedicated slot format, or determine whether to switch to a new slot format using the same BWP, as requested by the UE 104. In some examples, the base station 102 may base its determination on network traffic (e.g., a number of UEs and/or base stations communicating over the same operating band), a power saving mode used by the BS 102 (e.g., a green communication mode, sleep mode, etc.), or any other suitable power metric used by the base station 102.

In a third communication 910, the base station 102 may transmit, in response to the second communication 906, a response to the UE's 104 request indicating whether the base station 102 has accepted the UE's 104 request, has modified the UE's 104 request, or has denied the UE's 104 request. In response to the third communication 910, the UE 104 may perform a third process 912 by switching from the current BWP to a new BWP in accordance with the determination of the second process 908 of the base station 102. For example, if the base station 102 accepted the UE's 104 request or has modified the UE's 104 request, then the UE 104 may switch to the new BWP according to the request or the modification. If the base station denied the request, then the UE 104 may refrain from switching the current BWP to another BWP.

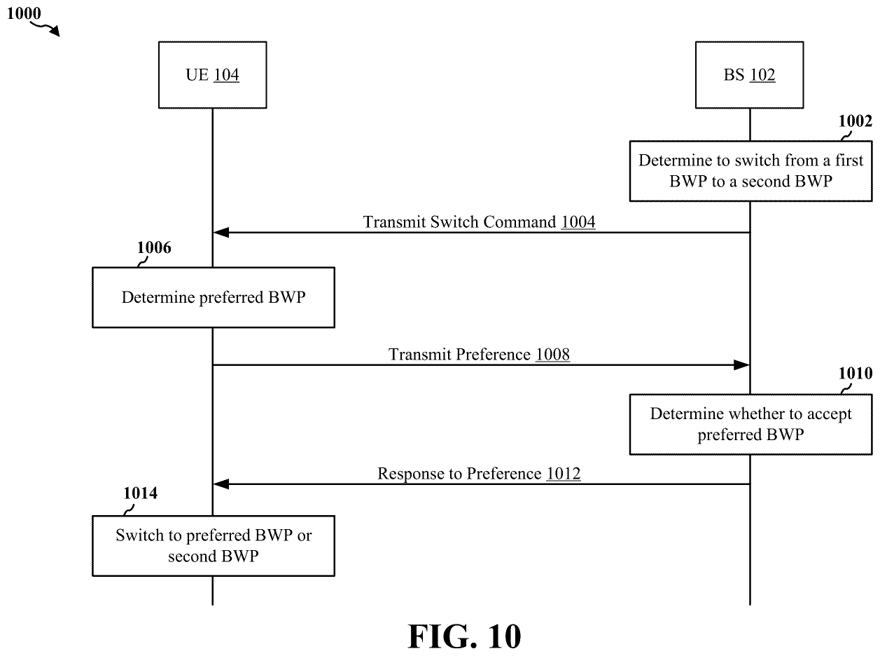

FIG. 10 is a call-flow diagram 1000 illustrating an exemplary flexible BWP switching procedure as it might occur in accordance with one example of communication between a UE 104 and a base station (BS) 102 (e.g., the UE 104 and base station 102 of FIG. 1). In this illustration, time progresses in the downward direction, and communication signals between the illustrated entities are denoted with arrows between the lines below the respective entities. As illustrated, the base station 102 and UE 104 are in communication using flexible BWPs. Each of the UE 104 and the base station are configured for communication over flexible BWPs using DL and UL TDD symbols.

Initially, the base station 102 and the UE 104 may communicate via a first BWP. At a first process 1002, the base station 102 may determine to switch from the first BWP to a second BWP. The first BWP may be defined by a first frequency bandwidth and a first slot format, and the second BWP may be defined by one or more of a second frequency band or a second slot format. In one example the base station 102 may determine to switch based on one or more of a PHR received from the UE 104, a power saving mode of the base station 102, traffic conditions of the operating band (e.g., if the UE 104 needs more opportunity for UL traffic, the base station 102 need more opportunity for DL traffic, or both), and/or a power mode of the base station 102 (e.g., a power saving mode or other power limitation of the base station 102). In some examples, the determination to switch from the first BWP to the second BWP may be defined by a determination to switch from one or more of the first frequency bandwidth to the second frequency bandwidth or from the first slot format to the second slot format.

In a first communication 1004, the base station 102 may transmit a BWP switch command to the UE 104, commanding the UE 104 to switch from the first BWP to the second BWP. The first communication 1004 may include an indication of the communication parameters associated with the second BWP.

In response to the BWP switch command, the UE 104 may determine a preferred BWP at a second process 1006. For example, the UE 104 may determine a preferred frequency band and/or a preferred slot format. The preferred frequency band and/or the preferred slot format may be the same as those used by the first BWP. The determination of the preferred BWP may be based on one or more of a communication metric or a power metric of the UE. For example, a UE power metric may relate to one or more of a UE battery level (e.g., battery life), UE power headroom (e.g., how much transmission power left for a UE to use in addition to the power being used by current transmission), and any other suitable power metrics. The communication metric may relate to traffic over the operating band, and/or an amount of UL communication required by the UE 104 (e.g., if the UE 104 needs to frequently transmit UL communications, or has relatively few UL communications).

In a second communication 1008, the UE 104 may transmit the determined preferred BWP. It should be noted, in some examples, the UE 104 may not switch from the first BWP to the second BWP in response to the first communication 1004 until after the UE 104 receives a response from the base station 102 to the second communication 1008. That is, the UE 104 may transmit the determined preferred BWP using the first BWP. However, in some examples, the UE 104 may make the switch according to the first communication 1004, and transmit the determined preferred BWP using the second BWP.

In a third process 1010, the base station 102 may determine whether to accept the UE's 104 preferred BWP. The base station 102 may determine to accept the preferred BWP in whole (e.g., if the preferred BWP includes a preferred BWP and a preferred slot format other than the second BWP, and both are accepted) or in part (e.g., if the preferred BWP includes a preferred BWP and a preferred slot format other than the second BWP, and only one is accepted), or to deny the preferred BWP in whole. The base station 102 may base the determination on traffic over the operating band, and/or an amount of UL communication required by the UE 104 (e.g., if the UE 104 needs to frequently transmit UL communications, or has relatively few UL communications), a PHR received from the UE 104, power saving modes of the UE 104, as well as power saving modes of the base station 102.

In a third communication 1012, the base station 102 may transmit a response to the second communication 1008 indicating whether the UE's 104 preferred BWP is accepted. If accepted in whole, the base station 102 may transmit an ACK or signaling that includes the communication parameters reflecting the UE's preferred BWP (e.g., preferred BWP bandwidth and preferred BWP slot format). If accepted in part, the base station 102 may transmit signaling that includes the communication parameters reflecting the accepted portion of the UE's preferred BWP (e.g., preferred BWP bandwidth or preferred BWP slot format) as well as communication parameters reflecting the BWP not accepted by the base station 102 (e.g., the second BWP bandwidth or the second BWP slot format). If denied, the base station 102 may transmit the communication parameters for the second BWP provided in the transmit switch command (e.g., the second BWP bandwidth and/or the second BWP slot format).

At a fourth process 1014, the UE 104 may switch the first BWP according to the communication parameters provided in the third communication (e.g., switch from the first BWP to the second BWP, the preferred BWP, or a combination thereof). The UE 104 and the base station 102 may then proceed to communicate according to the communication parameters provided in the third communication. Thus, if UE 104 determines that the communication parameters of the original switch command from the base station 102 does not align with the communication metrics of the UE or the power metrics of the UE 104, the UE 104 may determine to request to switch to different communication parameters, or maintain one or more of the current communication parameters.

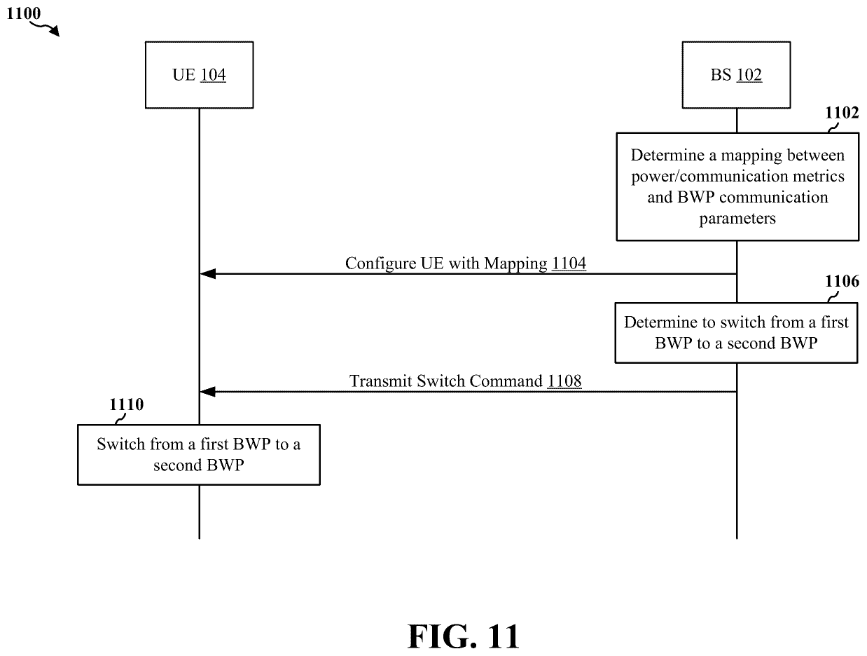

FIG. 11 is a call-flow diagram 1100 illustrating an exemplary flexible BWP switching procedure as it might occur in accordance with one example of communication between a UE 104 and a base station (BS) 102 (e.g., the UE 104 and base station 102 of FIG. 1). In this illustration, time progresses in the downward direction, and communication signals between the illustrated entities are denoted with arrows between the lines below the respective entities. As illustrated, the base station 102 and UE 104 are in communication using flexible BWPs. Each of the UE 104 and the base station are configured for communication over flexible BWPs using DL and UL TDD symbols.

At a first process 1102, the base station 102 may determine a mapping between (i) power metrics and/or communication metrics, and (ii) a slot format and/or a flexible BWP. For example, the table may include a plurality of UE battery life values, a plurality of PHR values, and/or a plurality of power saving modes of the UE 104 and/or base station 102 that correspond to one or more of a slot format or a flexible BWP bandwidth. Thus, for example, if the UE battery life is equal to a first value, the UE's power headroom is equal to a second value, an active power-saving mode used by the UE 104 is equal to a third value, and an active power-saving mode used by the base station 102 us equal to a fourth value, then the UE 104 and the base station 102 may find a row of the table that includes the first through fourth values and determine a slot format and/or a flexible BWP in the same row of the table. In certain aspects, the table may include communication metrics, such as a historical ratio of UL to DL communications between the UE 104 and the base station 102. That is, the mapping may provide the UE 104 and the base station 102 with an indication of a BWP bandwidth and/or a slot format for communication between the UE 104 and the base station 102 based on power metrics and/or communication metrics corresponding to the UE 104 and the base station 102. In certain aspects, the table may include any suitable power metrics and/or communication metrics.

At a first communication 1104, the base station 102 may configure the UE 104 with the determined mapping. For example, an indication of the mapping may be transmitted to the UE 104 via RRC messaging. At a second process 1106, the base station may determine to switch from a first BWP currently used by the base station 102 and UE 104 to a second BWP. For example, the base station 102 may determine a second BWP bandwidth and/or a second slot format based on how the second BWP maps to current power metrics and/or communication metrics of the UE 104 and/or base station 102.

In response to the determination, the base station 102 may transmit a switch command to the UE 104 via a second communication 1108. In certain aspects, the switch command may not include a communication parameter for the second BWP. Instead, at a third process 1110, the UE 104 may determine the communication parameters of the second BWP based on the mapping. In another example, the switch command may include a row number or an index corresponding to a row or entry of the mapping table that includes the communication parameters of the second BWP.

After receiving the switch command, the UE 104 may perform the third process 1110 by switching from the first BWP to the second BWP according to the switch command and the mapping. Thus, the base station 102 may reduce communication overhead by configuring the UE 104 with a mapping for different BWPs and their corresponding communication parameters according to one or more communication metrics and/or power metrics of the UE 104 and the base station 102.

It should be noted that although FIGS. 9-11 are illustrated as separate examples of a flexible BWP switching procedure, the processes and communications may be used interchangeably.

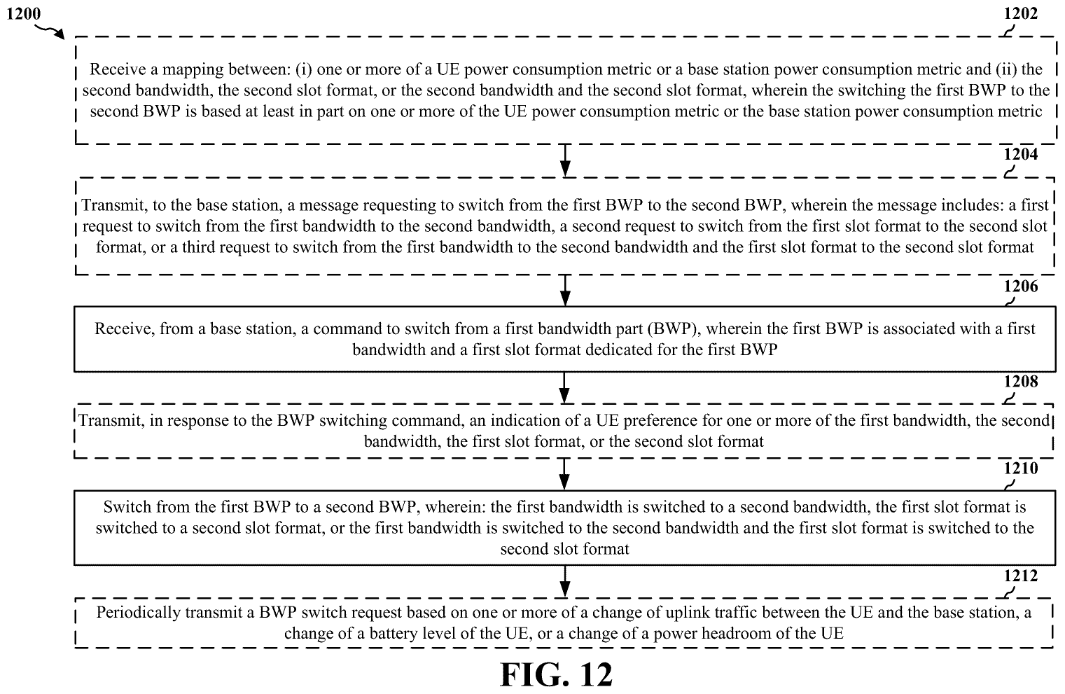

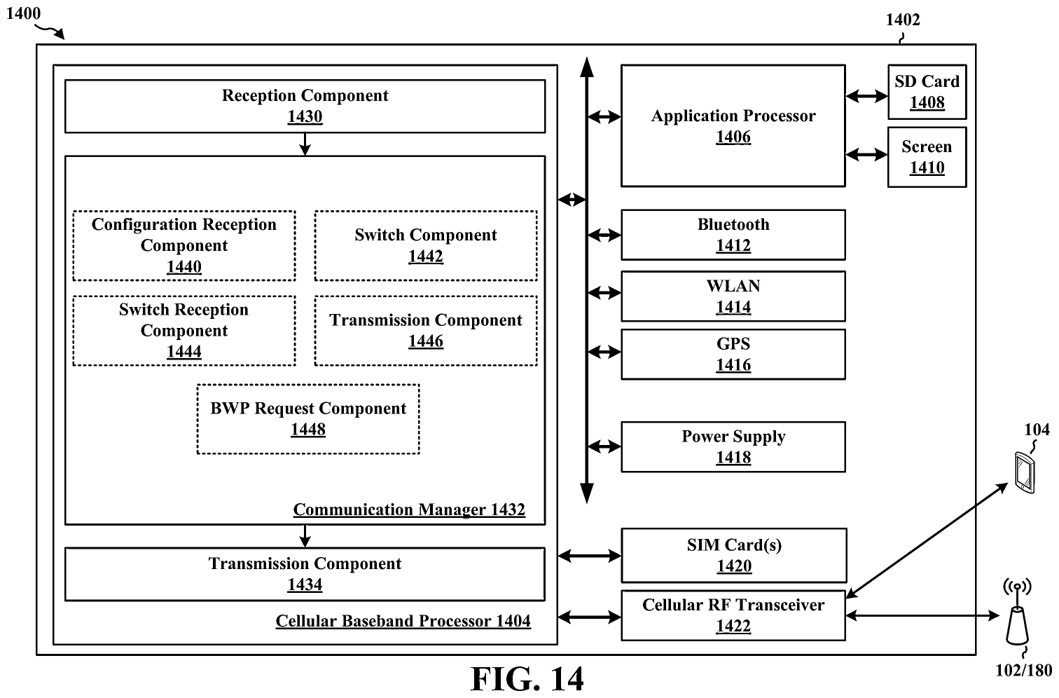

FIG. 12 is a flowchart 1200 of a method of wireless communication. The method may be performed by a UE (e.g., the UE 104 of FIGS. 1, 3, and 9-11; the apparatus 1402 of FIG. 14). Optional aspects are illustrated in dashed lines. The method allows a UE to switch between flexible BWPs according to one or more of a communication metric and/or a power metric of one or more of the UE or the base station.

At a first step 1202, the UE may receive a mapping between: (i) one or more of a UE power consumption metric or a base station power consumption metric and (ii) the second bandwidth, the second slot format, or the second bandwidth and the second slot format, wherein the switching the first BWP to the second BWP is based at least in part on one or more of the UE power consumption metric or the base station power consumption metric. For example, 1202 may be performed by configuration reception component 1440. For instance, referring to FIG. 11, the UE 104 may receive, from base station 102, a mapping configured by the base station 102 that maps one or more communication parameters (e.g., a BWP and its corresponding dedicated slot format, a BWP and another slot format, a common slot format, and/or another slot format) for a flexible BWP to one or more communication metrics and/or power metrics. In certain aspects, the UE power consumption metric comprises one or more of a battery level of the UE, or a power headroom of the UE, and wherein the base station power consumption metric comprises a power saving mode.

At a second step 1204, the UE may transmit, to the base station, a message requesting to switch from the first BWP to the second BWP, wherein the message includes: a first request to switch from the first bandwidth to the second bandwidth, a second request to switch from the first slot format to the second slot format, or a third request to switch from the first bandwidth to the second bandwidth and the first slot format to the second slot format. For example, the second step 1204 may be performed by a BWP request component 1448. For instance, referring to FIGS. 9 and 10, the UE 104 may determine to switch from a current BWP to a second BWP based on one or more communication metrics and/or power metrics of the UE 104 and/or the base station 102. For example, the UE 104 may determine that it needs more opportunities to transmit UL communications, so it may request a switch from the current BWP (e.g., the first BWP) to another BWP. The switch may request to change one or more of the bandwidth of the first BWP to a second bandwidth, or the slot format of the first BWP to a second slot format. Similarly, if the UE 104 receives a switch command from the base station 102 indicating a second BWP to switch to, the UE 104 may respond with a request to switch one or more of to a third bandwidth that is different from the bandwidth of the second BWP, or a third slot format that is different from the slot format of the second BWP. In certain aspects, the switching from the first BWP to the second BWP is made according to the first request, the second request, or the third request.

In certain aspects, the message requesting to switch from the first BWP to the second BWP is based on one or more of uplink traffic between the UE and the base station, a battery level of the UE, or power headroom of the UE.

In certain aspects, the message requesting to switch from the first BWP to the second BWP is transmitted via uplink control information (UCI).

At a third step 1206, the UE may receive, from a base station, a command to switch from a first bandwidth part (BWP), wherein the first BWP is associated with a first bandwidth and a first slot format dedicated for the first BWP. For example, the third step 1206 may be performed by a switch reception component 1444. In one example, the command to switch may include one or more communication parameters defining a second BWP, wherein the command is to switch from the first BWP to the second BWP. The second BWP may be defined by one or more of a second bandwidth or a second slot format dedicated for the second BWP. In another example, the command to switch may be based on a requested switch to the second BWP made by the UE. In this example, the command to switch may accept or modify the requested switch, and may include one or more of a bandwidth or a slot format associated with the flexible BWP of the accepted or modified switch request. In certain aspects, the command to switch from a first bandwidth part (BWP) is received via downlink control information (DCI).

At a fourth step 1208, the UE may transmit, in response to the BWP switching command, an indication of a UE preference for one or more of the first bandwidth, the second bandwidth, the first slot format, or the second slot format. For example, 1208 may be performed by the BWP request component 1448. For instance, referring to FIG. 10, the UE 104 may receive a switch command via the first communication 1004 from base station 102 indicating (e.g., in a bandwidth part indicator field) the UE 104 to switch at to another flexible BWP. In response to the command, the UE 104, at the second process 1006, may determine a preferred BWP that would be better suited to the UE 104 based on one or more of a communication metric or a power metric of the UE 104 and/or base station 102.

In certain aspects, the command to switch from the first BWP instructs the UE to: switch from the first bandwidth to the second bandwidth, switch from the first slot format to the second slot format, or switch from the first bandwidth to the second bandwidth and from the first slot format to the second slot format. In certain aspects, the switching from the first BWP to the second BWP is made according to one or more of the BWP switching command or the UE preference.

In certain aspects, the indication of the UE preference further comprises one or more of a third bandwidth associated with a third BWP, or a third slot format dedicated for the third BWP, and wherein: the first bandwidth is switched to the second bandwidth or the third bandwidth, the first slot format is switched to the second slot format or the third slot format, or the first bandwidth is switched to the second bandwidth or the third bandwidth, and the first slot format is switched to the second slot format or the third slot format.

At a fifth step 1210, the UE may switch from the first BWP to a second BWP, wherein: the first bandwidth is switched to a second bandwidth, the first slot format is switched to a second slot format, or the first bandwidth is switched to the second bandwidth and the first slot format is switched to the second slot format. For example, the fifth step 1210 may be performed by a switch component 1442. For instance, referring to FIGS. 9-11, the UE may switch from a first flexible BWP to a second flexible BWP based on a switching command (e.g., the third communication 910 of FIG. 9, the first communication 1004 and/or the third communication 1012 of FIG. 10, the second communication 1108 of FIG. 11) transmitted by the base station 102. The switch command may provide the UE 104 with communication parameters associated with the BWP to which the UE 104 will switch.

At a sixth step 1212, the UE may periodically transmit a BWP switch request based on one or more of a change of uplink traffic between the UE and the base station, a change of a battery level of the UE, or a change of a power headroom of the UE. For example, the sixth step 1212 may be performed by transmission component 1446. For instance, referring to FIGS. 9 and 10, the UE 104 may determine a preferred BWP (e.g., first process 904 of FIG. 9, second process of FIG. 10) based on one or more communication metrics of the UE 104 (e.g., uplink traffic between the UE and the base station) or power metrics of the UE 104 (e.g., a change of a battery level of the UE, or a change of a power headroom of the UE). It should be noted that the communication metrics may include any suitable communication metric of the UE 104 that affects the battery life and/or the power headroom of the UE, and the power metrics may include any suitable power metric of the UE that affects the power the UE can use to transmit uplink communications to the base station.

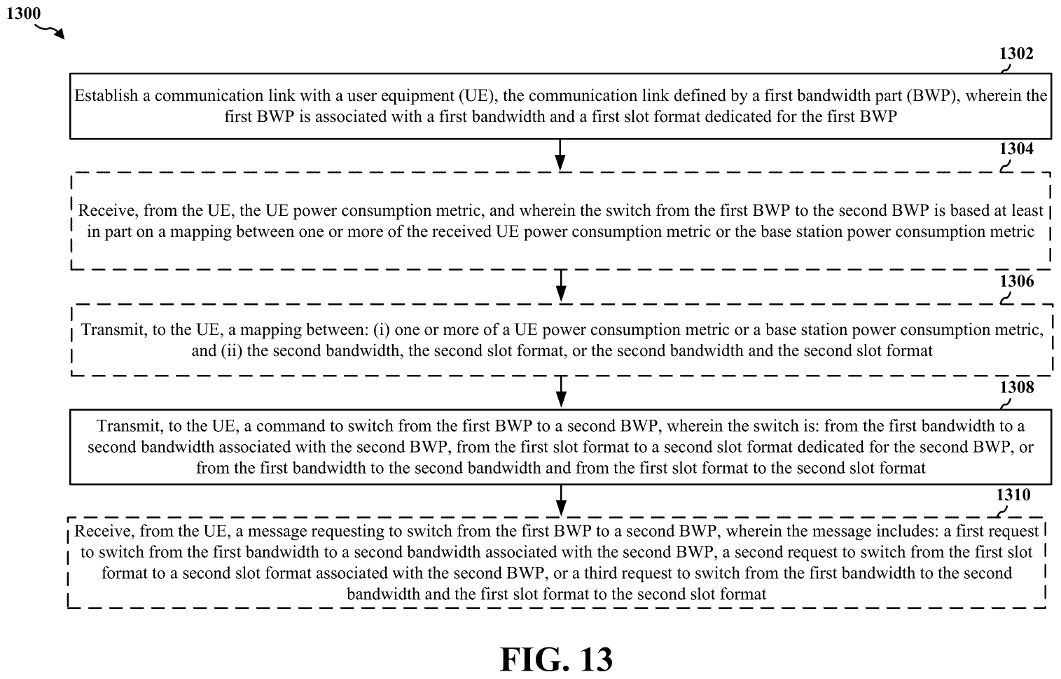

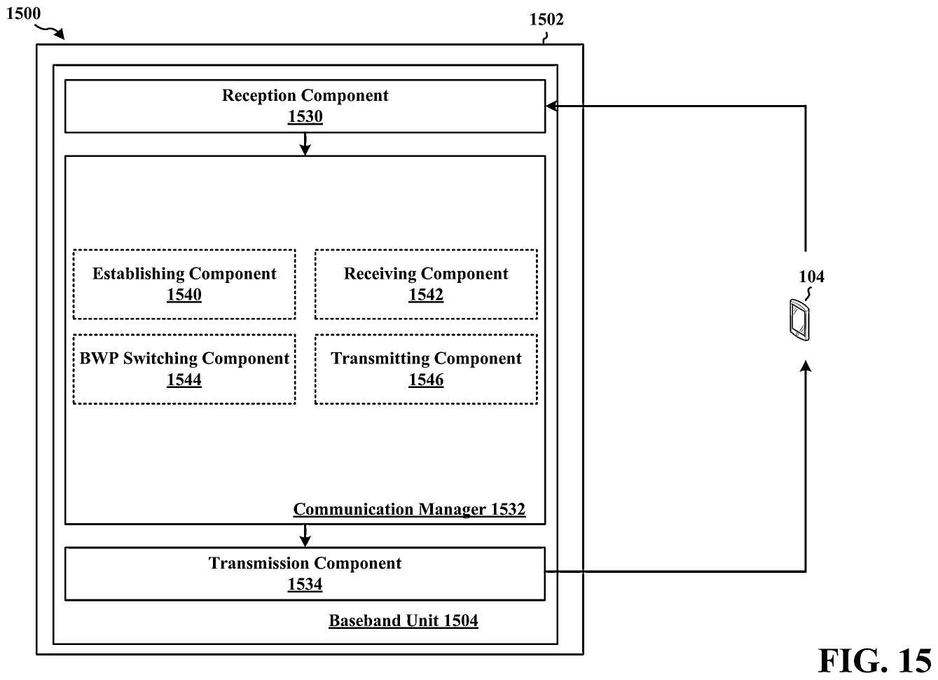

FIG. 13 is a flowchart 1300 of a method of wireless communication. The method may be performed by a base station (e.g., the base station 102/180 of FIGS. 1, 3, and 9-11; the apparatus 1502 of FIG. 15). Optional aspects are illustrated in dashed lines. The method allows a base station to configure flexible BWPs and to configure a UE to switch flexible BWPs according to one or more of a communication metric and/or a power metric of one or more of the UE or the base station.

At a first step 1302, the base station may establish a communication link with a user equipment (UE), the communication link defined by a first bandwidth part (BWP), wherein the first BWP is associated with a first bandwidth and a first slot format dedicated for the first BWP. For example, the first step 1302 may be performed by an establishing component 1540. For instance, the base station may first establish a communication link with the UE, then configure the UE to communicate with the base station over a first flexible BWP.

In certain aspects, the command to switch from the first BWP to the second BWP indicates the second BWP for the switching, and wherein the command to switch further indicates whether to maintain the first slot format for the second BWP. In certain aspects, the command to switch from the first BWP to the second BWP is transmitted in response to the message. In certain aspects, the message requesting to switch is received via uplink control information (UCI). In certain aspects, the command to switch from the first BWP is transmitted via downlink control information.

At a second step 1304, the base station may receive, from the UE, the UE power consumption metric, and wherein the switch from the first BWP to the second BWP is based at least in part on a mapping between one or more of the received UE power consumption metric or the base station power consumption metric. For example, the second step 1304 may be performed by a receiving component 1542. For example, the UE may transmit a power headroom report to the base station, or any other power consumption metric.

At a third step 1306, the base station may transmit, to the UE, a mapping between: (i) one or more of a UE power consumption metric or a base station power consumption metric, and (ii) the second bandwidth, the second slot format, or the second bandwidth and the second slot format. For example, the third step 1306 may be performed by a transmitting component 1546. For instance, the base station may transmit the determined mapping to the UE.

At a fourth step 1308, the base station may transmit, to the UE, a command to switch from the first BWP to a second BWP, wherein the switch is: from the first bandwidth to a second bandwidth associated with the second BWP, from the first slot format to a second slot format dedicated for the second BWP, or from the first bandwidth to the second bandwidth and from the first slot format to the second slot format. For example, the fourth step 1308 may be performed by a BWP switching component 1544. For instance, referring to FIGS. 9-11, the base station 102 may transmit a switching command (e.g., the third communication of FIG. 9, the first communication 1004 and the third communication 1012 of FIG. 10, the second communication 1108 of FIG. 11) to command the UE 104 to switch to a second BWP. It should be noted that a switching command may command the UE 104 to maintain a first bandwidth of the first BWP for the second BWP (e.g., by providing configuration information or DCI (if transmitted) indicating a same BWP index as BWP1 (in other words, that BWP2 is BWP1 in terms of bandwidth [but not necessarily slot format])), or may command the UE 104 to maintain the first slot format of the first BWP for the second BWP. Alternatively, the command may instruct the UE 104 to change both of the first bandwidth and the first slot format of the first BWP to a second bandwidth and a second slot format associated with the second BWP.

At a fifth step 1310, the base station may receive, from the UE, a message requesting to switch from the first BWP to a second BWP, wherein the message includes: a first request to switch from the first bandwidth to a second bandwidth associated with the second BWP, a second request to switch from the first slot format to a second slot format associated with the second BWP, or a third request to switch from the first bandwidth to the second bandwidth and the first slot format to the second slot format. For example, the fifth step 1310 may be performed by the receiving component 1542.

FIG. 14 is a diagram 1400 illustrating an example of a hardware implementation for an apparatus 1402. The apparatus 1402 is a UE and includes a cellular baseband processor 1404 (also referred to as a modem) coupled to a cellular RF transceiver 1422 and one or more subscriber identity modules (SIM) cards 1420, an application processor 1406 coupled to a secure digital (SD) card 1408 and a screen 1410, a Bluetooth module 1412, a wireless local area network (WLAN) module 1414, a Global Positioning System (GPS) module 1416, and a power supply 1418. The cellular baseband processor 1404 communicates through the cellular RF transceiver 1422 with the UE 104 and/or BS 102/180. The cellular baseband processor 1404 may include a computer-readable medium/memory. The computer-readable medium/memory may be non-transitory. The cellular baseband processor 1404 is responsible for general processing, including the execution of software stored on the computer-readable medium/memory. The software, when executed by the cellular baseband processor 1404, causes the cellular baseband processor 1404 to perform the various functions described supra. The computer-readable medium/memory may also be used for storing data that is manipulated by the cellular baseband processor 1404 when executing software. The cellular baseband processor 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the cellular baseband processor 1404. The cellular baseband processor 1404 may be a component of the UE 104 and may include the memory 360 and/or at least one of the TX processor 368, the RX processor 356, and the controller/processor 359. In one configuration, the apparatus 1402 may be a modem chip and include just the baseband processor 1404, and in another configuration, the apparatus 1402 may be the entire UE (e.g., see 104 of FIGS. 1 and 3) and include the aforediscussed additional modules of the apparatus 1402.

The communication manager 1432 includes a configuration reception component 1440 that is configured to receive a mapping between: (i) one or more of a UE power consumption metric or a base station power consumption metric and (ii) the second bandwidth, the second slot format, or the second bandwidth and the second slot format, wherein the switching the first BWP to the second BWP is based at least in part on one or more of the UE power consumption metric or the base station power consumption metric, e.g., as described in connection with the first step 1202 of FIG. 12.

The communication manager 1432 further includes a BWP request component 1448 that is configured to transmit, to the base station, a message requesting to switch from the first BWP to the second BWP, wherein the message includes: a first request to switch from the first bandwidth to the second bandwidth, a second request to switch from the first slot format to the second slot format, or a third request to switch from the first bandwidth to the second bandwidth and the first slot format to the second slot format, e.g., as described in connection with the second step 1204 of FIG. 12. The BWP request component 1448 may be further configured to transmit, in response to the BWP switching command, an indication of a UE preference for one or more of the first bandwidth, the second bandwidth, the first slot format, or the second slot format, e.g., as described in connection with the fourth step 1208 of FIG. 12.

The communication manager 1432 further includes a switch reception component 1444 that is configured to receive, from a base station, a command to switch from a first bandwidth part (BWP), wherein the first BWP is associated with a first bandwidth and a first slot format dedicated for the first BWP, e.g., as described in connection with the third step 1206 of FIG. 12.

The communication manager 1432 further includes a transmission component 1446 configured to periodically transmit a BWP switch request based on one or more of a change of uplink traffic between the UE and the base station, a change of a battery level of the UE, or a change of a power headroom of the UE, e.g., as described in connection with the sixth step 1212 of FIG. 12.

The apparatus may include additional components that perform each of the blocks of the algorithm in the aforementioned flowchart of FIG. 12. As such, each block in the aforementioned flowchart of FIG. 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1402, and in particular the cellular baseband processor 1404, includes means for receiving, from a base station, a command to switch from a first bandwidth part (BWP), wherein the first BWP is associated with a first bandwidth and a first slot format dedicated for the first BWP; and switching from the first BWP to a second BWP, wherein: the first bandwidth is switched to a second bandwidth, the first slot format is switched to a second slot format, or the first bandwidth is switched to the second bandwidth and the first slot format is switched to the second slot format.

In one configuration, the apparatus 1402, and in particular the cellular baseband processor 1404, may include means for transmitting, to the base station, a message requesting to switch from the first BWP to the second BWP, wherein the message includes: a first request to switch from the first bandwidth to the second bandwidth, a second request to switch from the first slot format to the second slot format, or a third request to switch from the first bandwidth to the second bandwidth and the first slot format to the second slot format, and wherein the switching from the first BWP to the second BWP is made according to the first request, the second request, or the third request.

In one configuration, the apparatus 1402, and in particular the cellular baseband processor 1404, may include means for periodically transmitting a BWP switch request based on one or more of a change of uplink traffic between the UE and the base station, a change of a battery level of the UE, or a change of a power headroom of the UE.

In one configuration, the apparatus 1402, and in particular the cellular baseband processor 1404, may include means for transmitting, in response to the BWP switching command, an indication of a UE preference for one or more of the first bandwidth, the second bandwidth, the first slot format, or the second slot format, wherein the switching from the first BWP to the second BWP is made according to one or more of the BWP switching command or the UE preference.

In one configuration, the apparatus 1402, and in particular the cellular baseband processor 1404, may include means for receiving a mapping between: (i) one or more of a UE power consumption metric or a base station power consumption metric and (ii) the second bandwidth, the second slot format, or the second bandwidth and the second slot format, wherein the switching the first BWP to the second BWP is based at least in part on one or more of the UE power consumption metric or the base station power consumption metric.

The aforementioned means may be one or more of the aforementioned components of the apparatus 1402 configured to perform the functions recited by the aforementioned means. As described supra, the apparatus 1402 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

FIG. 15 is a diagram 1500 illustrating an example of a hardware implementation for an apparatus 1502. The apparatus 1502 is a BS and includes a baseband unit 1504. The baseband unit 1504 may communicate through a cellular RF transceiver with the UE 104. The baseband unit 1504 may include a computer-readable medium/memory. The baseband unit 1504 is responsible for general processing, including the execution of software stored on the computer-readable medium/memory. The software, when executed by the baseband unit 1504, causes the baseband unit 1504 to perform the various functions described supra. The computer-readable medium/memory may also be used for storing data that is manipulated by the baseband unit 1504 when executing software. The baseband unit 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the baseband unit 1504. The baseband unit 1504 may be a component of the BS 102 and may include the memory 376 and/or at least one of the TX processor 316, the RX processor 370, and the controller/processor 375.

The communication manager 1532 includes an establishing component 1540 that is configured to establish a communication link with a user equipment (UE), the communication link defined by a first bandwidth part (BWP), wherein the first BWP is associated with a first bandwidth and a first slot format dedicated for the first BWP, as described in the first step 1302 of FIG. 13.

The communication manager 1532 further includes a receiving component 1542 that is configured to receive, from the UE, the UE power consumption metric, and wherein the switch from the first BWP to the second BWP is based at least in part on a mapping between one or more of the received UE power consumption metric or the base station power consumption metric, e.g., as described in connection with the second step 1304 of FIG. 13. The receiving component may be further configured to receive, from the UE, a message requesting to switch from the first BWP to a second BWP, wherein the message includes: a first request to switch from the first bandwidth to a second bandwidth associated with the second BWP, a second request to switch from the first slot format to a second slot format associated with the second BWP, or a third request to switch from the first bandwidth to the second bandwidth and the first slot format to the second slot format, e.g., as described in connection with the fifth step 1310 of FIG. 13.

The communication manager 1532 further includes a BWP switching component 1544 that is configured to transmit, to the UE, a mapping between: (i) one or more of a UE power consumption metric or a base station power consumption metric, and (ii) the second bandwidth, the second slot format, or the second bandwidth and the second slot format, e.g., as described in connection with the third step 1306 of FIG. 13. The BWP switching component 1544 may be further configured to transmit, to the UE, a command to switch from the first BWP to a second BWP, wherein the switch is: from the first bandwidth to a second bandwidth associated with the second BWP, from the first slot format to a second slot format dedicated for the second BWP, or from the first bandwidth to the second bandwidth and from the first slot format to the second slot format, e.g., as described on connection with the fourth step 1308 of FIG. 13.

The communication manager 1532 further includes a transmitting component 1546 that is configured to transmit DCI to the UE, where the DCI indicates the second BWP for the switching, and the first slot format is switched to the second slot format based on the DCI and the slot format switching behavior of the RRC configuration, e.g., as described in connection with 1310.

The apparatus may include additional components that perform each of the blocks of the algorithm in the aforementioned flowchart of FIG. 13. As such, each block in the aforementioned flowchart of FIG. 13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1502, and in particular the baseband unit 1504, includes means for establishing a communication link with a user equipment (UE), the communication link defined by a first bandwidth part (BWP), wherein the first BWP is associated with a first bandwidth and a first slot format dedicated for the first BWP; and transmitting, to the UE, a command to switch from the first BWP to a second BWP, wherein the switch is: from the first bandwidth to a second bandwidth associated with the second BWP, from the first slot format to a second slot format dedicated for the second BWP, or from the first bandwidth to the second bandwidth and from the first slot format to the second slot format.

In one configuration, the apparatus 1502, and in particular the baseband unit 1504, includes means for receiving, from the UE, a message requesting to switch from the first BWP to a second BWP, wherein the message includes: a first request to switch from the first bandwidth to a second bandwidth associated with the second BWP, a second request to switch from the first slot format to a second slot format associated with the second BWP, or a third request to switch from the first bandwidth to the second bandwidth and the first slot format to the second slot format; and wherein the command to switch from the first BWP to the second BWP is transmitted in response to the message.

In one configuration, the apparatus 1502, and in particular the baseband unit 1504, may include means for transmitting, to the UE, a mapping between: (i) one or more of a UE power consumption metric or a base station power consumption metric, and (ii) the second bandwidth, the second slot format, or the second bandwidth and the second slot format.

In one configuration, the apparatus 1502, and in particular the baseband unit 1504, may include means for receiving, from the UE, the UE power consumption metric, and wherein the switch from the first BWP to the second BWP is based at least in part on a mapping between one or more of the received UE power consumption metric or the base station power consumption metric.

The aforementioned means may be one or more of the aforementioned components of the apparatus 1502 configured to perform the functions recited by the aforementioned means. As described supra, the apparatus 1502 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is an apparatus for wireless communication by a user equipment (UE) comprising a processor; a memory coupled with the processor; and instructions stored in the memory and operable, when executed by the processor, to cause the apparatus to: receive, from a base station, a command to switch from a first bandwidth part (BWP), wherein the first BWP is associated with a first bandwidth and a first slot format dedicated for the first BWP; and switch from the first BWP to a second BWP, wherein: the first bandwidth is switched to a second bandwidth, the first slot format is switched to a second slot format, or the first bandwidth is switched to the second bandwidth and the first slot format is switched to the second slot format.

Example 2 is the apparatus of Example 1, wherein the instructions, when executed by the processor, further cause the apparatus to transmit, to the base station, a message requesting to switch from the first BWP to the second BWP, wherein the message includes: a first request to switch from the first bandwidth to the second bandwidth, a second request to switch from the first slot format to the second slot format, or a third request to switch from the first bandwidth to the second bandwidth and the first slot format to the second slot format, and wherein the switch from the first BWP to the second BWP is made according to the first request, the second request, or the third request.

Example 3 is the apparatus of any of Examples 1 or 2, wherein the message requesting to switch from the first BWP to the second BWP is based on one or more of uplink traffic between the UE and the base station, a battery level of the UE, or power headroom of the UE.

Example 4 is the apparatus of any of Examples 1-3, wherein the message requesting to switch from the first BWP to the second BWP is transmitted via uplink control information (UCI).

Example 5 is the apparatus of any of Examples 1-4, wherein the instructions, when executed by the processor, further cause the apparatus to periodically transmit a BWP switch request based on one or more of a change of uplink traffic between the UE and the base station, a change of a battery level of the UE, or a change of a power headroom of the UE.

Example 6 is the apparatus of any of Examples 1-5, wherein the command to switch from the first BWP instructs the UE to: switch from the first bandwidth to the second bandwidth, switch from the first slot format to the second slot format, or switch from the first bandwidth to the second bandwidth and from the first slot format to the second slot format, and wherein the instructions, when executed by the processor, further cause the apparatus to transmit, in response to the BWP switching command, an indication of a UE preference for one or more of the first bandwidth, the second bandwidth, the first slot format, or the second slot format, and wherein the switch from the first BWP to the second BWP is made according to one or more of the BWP switching command or the UE preference.

Example 7 is the apparatus of Example 6, wherein the indication of the UE preference further comprises one or more of a third bandwidth associated with a third BWP, or a third slot format dedicated for the third BWP, and wherein: the first bandwidth is switched to the second bandwidth or the third bandwidth, the first slot format is switched to the second slot format or the third slot format, or the first bandwidth is switched to the second bandwidth or the third bandwidth, and the first slot format is switched to the second slot format or the third slot format.

Example 8 is the apparatus of any of Examples 1-6, wherein the instructions, when executed by the processor, further cause the apparatus to receive a mapping between: (i) one or more of a UE power consumption metric or a base station power consumption metric and (ii) the second bandwidth, the second slot format, or the second bandwidth and the second slot format, wherein the switch from the first BWP to the second BWP is based at least in part on one or more of the UE power consumption metric or the base station power consumption metric.

Example 9 is the apparatus of Example 8, wherein the UE power consumption metric comprises one or more of a battery level of the UE, or a power headroom of the UE, and wherein the base station power consumption metric comprises a power saving mode.

Example 10 is the apparatus of any of examples 1-9, wherein the command to switch from a first bandwidth part (BWP) is received via downlink control information (DCI).

Example 11 is an apparatus for wireless communication by a base station, comprising: a processor; a memory coupled with the processor; and instructions stored in the memory and operable, when executed by the processor, to cause the apparatus to: establish a communication link with a user equipment (UE), the communication link defined by a first bandwidth part (BWP), wherein the first BWP is associated with a first bandwidth and a first slot format dedicated for the first BWP; and transmit, to the UE, a command to switch from the first BWP to a second BWP, wherein the switch is: from the first bandwidth to a second bandwidth associated with the second BWP, from the first slot format to a second slot format dedicated for the second BWP, or from the first bandwidth to the second bandwidth and from the first slot format to the second slot format.

Example 12 is the apparatus of Example 11, wherein the command to switch from the first BWP to the second BWP indicates the second BWP for the switching, and wherein the command to switch further indicates whether to maintain the first slot format for the second BWP.

Example 13 is the apparatus of any of Examples 11 and 12, wherein the instructions, when executed by the processor, further cause the apparatus to receive, from the UE, a message requesting to switch from the first BWP to a second BWP, wherein the message includes: a first request to switch from the first bandwidth to a second bandwidth associated with the second BWP, a second request to switch from the first slot format to a second slot format associated with the second BWP, or a third request to switch from the first bandwidth to the second bandwidth and the first slot format to the second slot format; and wherein the command to switch from the first BWP to the second BWP is transmitted in response to the message.

Example 14 is the apparatus of any of Examples 11-13, wherein the message requesting to switch is received via uplink control information (UCI).

Example 15 is the apparatus of any of Examples 11-14, wherein the instructions, when executed by the processor, further cause the apparatus to transmit, to the UE, a mapping between: (i) one or more of a UE power consumption metric or a base station power consumption metric, and (ii) the second bandwidth, the second slot format, or the second bandwidth and the second slot format.

Example 16 is the apparatus of Example 15, wherein the instructions, when executed by the processor, further cause the apparatus to receive, from the UE, the UE power consumption metric, and wherein the switch from the first BWP to the second BWP is based at least in part on a mapping between one or more of the received UE power consumption metric or the base station power consumption metric.

Example 17 is the apparatus of any of Examples 11-16, wherein the command to switch from the first BWP is transmitted via downlink control information.

Example 18 is a method of wireless communication at a user equipment (UE), comprising: receiving, from a base station, a command to switch from a first bandwidth part (BWP), wherein the first BWP is associated with a first bandwidth and a first slot format dedicated for the first BWP; and switching from the first BWP to a second BWP, wherein: the first bandwidth is switched to a second bandwidth, the first slot format is switched to a second slot format, or the first bandwidth is switched to the second bandwidth and the first slot format is switched to the second slot format.

Example 19 is the method of Example 18, further comprising transmitting, to the base station, a message requesting to switch from the first BWP to the second BWP, wherein the message includes: a first request to switch from the first bandwidth to the second bandwidth, a second request to switch from the first slot format to the second slot format, or a third request to switch from the first bandwidth to the second bandwidth and the first slot format to the second slot format, and wherein the switching from the first BWP to the second BWP is made according to the first request, the second request, or the third request.

Example 20 is the method of any of Examples 18 and 19, wherein the message requesting to switch from the first BWP to the second BWP is based on one or more of uplink traffic between the UE and the base station, a battery level of the UE, or power headroom of the UE.

Example 21 is the method of any of Examples 18-20, wherein the message requesting to switch from the first BWP to the second BWP is transmitted via uplink control information (UCI).

Example 22 is the method of any of Examples 18-21, further comprising periodically transmitting a BWP switch request based on one or more of a change of uplink traffic between the UE and the base station, a change of a battery level of the UE, or a change of a power headroom of the UE.

Example 23 is the method of any of Examples 18-22, wherein the command to switch from the first BWP instructs the UE to: switch from the first bandwidth to the second bandwidth, switch from the first slot format to the second slot format, or switch from the first bandwidth to the second bandwidth and from the first slot format to the second slot format, and wherein the method further comprises transmitting, in response to the BWP switching command, an indication of a UE preference for one or more of the first bandwidth, the second bandwidth, the first slot format, or the second slot format, and wherein the switching from the first BWP to the second BWP is made according to one or more of the BWP switching command or the UE preference.

Example 24 is the method of Example 23, wherein the indication of the UE preference further comprises one or more of a third bandwidth associated with a third BWP, or a third slot format dedicated for the third BWP, and wherein: the first bandwidth is switched to the second bandwidth or the third bandwidth, the first slot format is switched to the second slot format or the third slot format, or the first bandwidth is switched to the second bandwidth or the third bandwidth, and the first slot format is switched to the second slot format or the third slot format.

Example 25 is the method of any of Examples 18-24, further comprising receiving a mapping between: (i) one or more of a UE power consumption metric or a base station power consumption metric and (ii) the second bandwidth, the second slot format, or the second bandwidth and the second slot format, wherein the switching the first BWP to the second BWP is based at least in part on one or more of the UE power consumption metric or the base station power consumption metric.

Example 26 is the method of Example 25, wherein the UE power consumption metric comprises one or more of a battery level of the UE, or a power headroom of the UE, and wherein the base station power consumption metric comprises a power saving mode.

Example 27 is the method of any of Examples 18-26, wherein the command to switch from a first bandwidth part (BWP) is received via downlink control information (DCI).

Example 28 is a method for wireless communication by a base station, comprising: establishing a communication link with a user equipment (UE), the communication link defined by a first bandwidth part (BWP), wherein the first BWP is associated with a first bandwidth and a first slot format dedicated for the first BWP; and transmitting, to the UE, a command to switch from the first BWP to a second BWP, wherein the switch is: from the first bandwidth to a second bandwidth associated with the second BWP, from the first slot format to a second slot format dedicated for the second BWP, or from the first bandwidth to the second bandwidth and from the first slot format to the second slot format.

Example 29 is the method of Example 28, wherein the command to switch from the first BWP to the second BWP indicates the second BWP for the switching, and wherein the command to switch further indicates whether to maintain the first slot format for the second BWP.

Example 30 is the method of any of Examples 28 and 29, further comprising receiving, from the UE, a message requesting to switch from the first BWP to a second BWP, wherein the message includes: a first request to switch from the first bandwidth to a second bandwidth associated with the second BWP, a second request to switch from the first slot format to a second slot format associated with the second BWP, or a third request to switch from the first bandwidth to the second bandwidth and the first slot format to the second slot format; and wherein the command to switch from the first BWP to the second BWP is transmitted in response to the message.

Example 31 is the method of any of Examples 28-30, wherein the message requesting to switch is received via uplink control information (UCI).

Example 32 is the method of any of Examples 28-31, further comprising transmitting, to the UE, a mapping between: (i) one or more of a UE power consumption metric or a base station power consumption metric, and (ii) the second bandwidth, the second slot format, or the second bandwidth and the second slot format.

Example 33 is the method of Example 32, further comprising receiving, from the UE, the UE power consumption metric, and wherein the switch from the first BWP to the second BWP is based at least in part on a mapping between one or more of the received UE power consumption metric or the base station power consumption metric.

Example 34 is the method of any of Examples 28-33, wherein the command to switch from the first BWP is transmitted via downlink control information.

Example 35 is a user equipment (UE) comprising: one or more means for performing the method of any of Examples 18-27.

Example 36 is a base station comprising: one or more means for performing the method of any of Examples 28-34.

A non-transitory computer-readable storage medium having instructions stored thereon for performing the method of any of claims 18-27 for wireless communication by a user equipment (UE).

A non-transitory computer-readable storage medium having instructions stored thereon for performing the method of any of claims 28-34 for wireless communication by a base station.

What is claimed is:

1. An apparatus for wireless communication by a user equipment (UE), comprising:
a processor;
memory coupled with the processor; and
instructions stored in the memory and operable, when executed by the processor, to cause the apparatus to:
receive, from a base station, a command to switch from a first bandwidth part (BWP), wherein the first BWP is associated with a first bandwidth and a first slot format dedicated for the first BWP; and
switch from the first BWP to a second BWP, wherein:
the first bandwidth is switched to a second bandwidth,
the first slot format is switched to a second slot format, or
the first bandwidth is switched to the second bandwidth and the first slot format is switched to the second slot format.

2. The apparatus of claim 1, wherein the instructions, when executed by the processor, further cause the apparatus to transmit, to the base station, a message requesting to switch from the first BWP to the second BWP, wherein the message includes:
a first request to switch from the first bandwidth to the second bandwidth,
a second request to switch from the first slot format to the second slot format, or
a third request to switch from the first bandwidth to the second bandwidth and the first slot format to the second slot format, and
wherein the switch from the first BWP to the second BWP is made according to the first request, the second request, or the third request.

3. The apparatus of claim 2, wherein the message requesting to switch from the first BWP to the second BWP is based on one or more of uplink traffic between the UE and the base station, a battery level of the UE, or power headroom of the UE.

4. The apparatus of claim 2, wherein the message requesting to switch from the first BWP to the second BWP is transmitted via uplink control information (UCI).

5. The apparatus of claim 2, wherein the instructions, when executed by the processor, further cause the apparatus to periodically transmit a BWP switch request based on one or more of a change of uplink traffic between the UE and the base station, a change of a battery level of the UE, or a change of a power headroom of the UE.

6. The apparatus of claim 1, wherein the command to switch from the first BWP instructs the UE to:
switch from the first bandwidth to the second bandwidth,
switch from the first slot format to the second slot format, or
switch from the first bandwidth to the second bandwidth and from the first slot format to the second slot format, and
wherein the instructions, when executed by the processor, further cause the apparatus to transmit, in response to the BWP switching command, an indication of a UE preference for one or more of the first bandwidth, the second bandwidth, the first slot format, or the second slot format, and
wherein the switch from the first BWP to the second BWP is made according to one or more of the BWP switching command or the UE preference.

7. The apparatus of claim 6, wherein the indication of the UE preference further comprises one or more of a third bandwidth associated with a third BWP, or a third slot format dedicated for the third BWP, and wherein:
the first bandwidth is switched to the second bandwidth or the third bandwidth,
the first slot format is switched to the second slot format or the third slot format, or
the first bandwidth is switched to the second bandwidth or the third bandwidth, and the first slot format is switched to the second slot format or the third slot format.

8. The apparatus of claim 1, wherein the instructions, when executed by the processor, further cause the apparatus to receive a mapping between: (i) one or more of a UE power consumption metric or a base station power consumption metric and (ii) the second bandwidth, the second slot format, or the second bandwidth and the second slot format, wherein the switch from the first BWP to the second BWP is based at least in part on one or more of the UE power consumption metric or the base station power consumption metric.

9. The apparatus of claim 8, wherein the UE power consumption metric comprises one or more of a battery level of the UE, or a power headroom of the UE, and wherein the base station power consumption metric comprises a power saving mode.

10. The apparatus of claim 1, wherein the command to switch from a first bandwidth part (BWP) is received via downlink control information (DCI).

11. An apparatus for wireless communication by a base station, comprising:
a processor;
memory coupled with the processor; and
instructions stored in the memory and operable, when executed by the processor, to cause the apparatus to:
establish a communication link with a user equipment (UE), the communication link defined by a first bandwidth part (BWP), wherein the first BWP is associated with a first bandwidth and a first slot format dedicated for the first BWP; and
transmit, to the UE, a command to switch from the first BWP to a second BWP, wherein the switch is:
from the first bandwidth to a second bandwidth associated with the second BWP,
from the first slot format to a second slot format dedicated for the second BWP, or
from the first bandwidth to the second bandwidth and from the first slot format to the second slot format.

12. The apparatus of claim 11, wherein the command to switch from the first BWP to the second BWP indicates the second BWP for the switching, and wherein the command to switch further indicates whether to maintain the first slot format for the second BWP.

13. The apparatus of claim 11, wherein the instructions, when executed by the processor, further cause the apparatus to receive, from the UE, a message requesting to switch from the first BWP to a second BWP, wherein the message includes:
a first request to switch from the first bandwidth to a second bandwidth associated with the second BWP,
a second request to switch from the first slot format to a second slot format associated with the second BWP, or
a third request to switch from the first bandwidth to the second bandwidth and the first slot format to the second slot format; and
and wherein the command to switch from the first BWP to the second BWP is transmitted in response to the message.

14. The apparatus of claim 13, wherein the message requesting to switch is received via uplink control information (UCI).

15. The apparatus of claim 11, wherein the instructions, when executed by the processor, further cause the apparatus to transmit, to the UE, a mapping between: (i) one or more of a UE power consumption metric or a base station power consumption metric, and (ii) the second bandwidth, the second slot format, or the second bandwidth and the second slot format.

16. The apparatus of claim 15, wherein the instructions, when executed by the processor, further cause the apparatus to receive, from the UE, the UE power consumption metric, and wherein the switch from the first BWP to the second BWP is based at least in part on a mapping between one or more of the received UE power consumption metric or the base station power consumption metric.

17. The apparatus of claim 11, wherein the command to switch from the first BWP is transmitted via downlink control information.

18. A method of wireless communication at a user equipment (UE), comprising:
receiving, from a base station, a command to switch from a first bandwidth part (BWP), wherein the first BWP is associated with a first bandwidth and a first slot format dedicated for the first BWP; and
switching from the first BWP to a second BWP, wherein:
the first bandwidth is switched to a second bandwidth,
the first slot format is switched to a second slot format, or
the first bandwidth is switched to the second bandwidth and the first slot format is switched to the second slot format.

19. The method of claim 18, further comprising transmitting, to the base station, a message requesting to switch from the first BWP to the second BWP, wherein the message includes:
a first request to switch from the first bandwidth to the second bandwidth,
a second request to switch from the first slot format to the second slot format, or
a third request to switch from the first bandwidth to the second bandwidth and the first slot format to the second slot format; and
wherein the switching from the first BWP to the second BWP is made according to the first request, the second request, or the third request.

20. The method of claim 19, wherein the message requesting to switch from the first BWP to the second BWP is based on one or more of uplink traffic between the UE and the base station, a battery level of the UE, or power headroom of the UE.

21. The method of claim 19, wherein the message requesting to switch from the first BWP to the second BWP is transmitted via uplink control information (UCI).

22. The method of claim 19, further comprising periodically transmitting a BWP switch request based on one or more of a change of uplink traffic between the UE and the base station, a change of a battery level of the UE, or a change of a power headroom of the UE.

23. The method of claim 18, wherein the command to switch from the first BWP instructs the UE to:
switch from the first bandwidth to the second bandwidth,
switch from the first slot format to the second slot format, or
switch from the first bandwidth to the second bandwidth and from the first slot format to the second slot format, and
wherein the method further comprises transmitting, in response to the BWP switching command, an indication of a UE preference for one or more of the first bandwidth, the second bandwidth, the first slot format, or the second slot format, and
wherein the switching from the first BWP to the second BWP is made according to one or more of the BWP switching command or the UE preference.

24. The method of claim 23, wherein the indication of the UE preference further comprises one or more of a third bandwidth associated with a third BWP, or a third slot format dedicated for the third BWP, and wherein:
the first bandwidth is switched to the second bandwidth or the third bandwidth,
the first slot format is switched to the second slot format or the third slot format, or
the first bandwidth is switched to the second bandwidth or the third bandwidth, and the first slot format is switched to the second slot format or the third slot format.

25. The method of claim 18, further comprising receiving a mapping between: (i) one or more of a UE power consumption metric or a base station power consumption metric and (ii) the second bandwidth, the second slot format, or the second bandwidth and the second slot format, wherein the switching the first BWP to the second BWP is based at least in part on one or more of the UE power consumption metric or the base station power consumption metric.

26. The method of claim 25, wherein the UE power consumption metric comprises one or more of a battery level of the UE, or a power headroom of the UE, and wherein the base station power consumption metric comprises a power saving mode.

27. The method of claim 18, wherein the command to switch from a first bandwidth part (BWP) is received via downlink control information (DCI).

28. A method for wireless communication by a base station, comprising:
establishing a communication link with a user equipment (UE), the communication link defined by a first bandwidth part (BWP), wherein the first BWP is associated with a first bandwidth and a first slot format dedicated for the first BWP; and
transmitting, to the UE, a command to switch from the first BWP to a second BWP, wherein the switch is:
from the first bandwidth to a second bandwidth associated with the second BWP,
from the first slot format to a second slot format dedicated for the second BWP, or
from the first bandwidth to the second bandwidth and from the first slot format to the second slot format.

29. The method of claim 28, wherein the command to switch from the first BWP to the second BWP indicates the second BWP for the switching, and wherein the command to switch further indicates whether to maintain the first slot format for the second BWP.

30. The method of claim 28, further comprising receiving, from the UE, a message requesting to switch from the first BWP to a second BWP, wherein the message includes:
a first request to switch from the first bandwidth to a second bandwidth associated with the second BWP,
a second request to switch from the first slot format to a second slot format associated with the second BWP, or
a third request to switch from the first bandwidth to the second bandwidth and the first slot format to the second slot format; and
and wherein the command to switch from the first BWP to the second BWP is transmitted in response to the message.
